(19) United States
(12) Patent Application Publication
(10) Pub. No.: US 2012/0104097 A1
(43) Pub. Date: May 3, 2012

(54) READING DEVICE ABLE TO IDENTIFY A TAG OR AN OBJECT ADAPTED TO BE IDENTIFIED, RELATED METHODS AND SYSTEMS

(75) Inventors: Peter Malcolm Moran, Singapore (SG); Adrian Paul Burden, Malvern (GB)

(73) Assignee: BILCARE TECHNOLOGIES SINGAPORE PTE. LTD., Singapore (SG)

(21) Appl. No.: 13/382,925

(22) PCT Filed: Jul. 8, 2010
(86) PCT No.: PCT/SG2010/000259

§ 371 Date: Jan. 8, 2012

Related U.S. Application Data
(60) Provisional application No. 61/224,128, filed on Jul. 9, 2009.

(51) Int. Cl. G06K 7/08; G06K 7/14

(52) U.S. Cl. 235/449

(57) ABSTRACT

A reading device for identifying a tag or an object adapted to be identified is disclosed. The reading device includes a reading element for reading a first set of identification features located in the tag or the object adapted to be identified, wherein the reading element is a magneto-optical reading element. The reading element also reads a second set of identification features located in the tag or the object adapted to be identified; wherein the reading device is configured such that a first signal generated from reading the first set of identification features and a second signal generated from reading the second set of identification features are independently used to derive a first signature and a second signature for identifying the tag or object.

### CROSS-REFERENCE TO RELATED APPLICATIONS

This application makes reference to and claims the benefit of priority of U.S. provisional patent application 61/224,128, filed with the United States Patent and Trademark Office on Jul. 9, 2009. The content of said U.S. provisional patent application 61/224,128 is incorporated herein by reference for all purposes in its entirety.

### FIELD OF THE INVENTION

Embodiments of the invention relate to the field of reading devices. By way of example, embodiments of the invention relate to a reading device able to identify a tag or an object to be identified, related methods and systems.

### BACKGROUND OF THE INVENTION

Recently, use of a magnetic field for identification purposes has been very extensive and vital. This can be seen in a myriad of secured articles which utilize magnetic patterns or magnetic particles as their identification means. Some examples include security documents such as cheques, credit cards or tickets which typically use magnetic inks or magnetic strips for storing encrypted security information. Other examples include anti-counterfeit tags which use magnetic particles to create a random arrangement which acts as a magnetic fingerprint. In addition, magnetic barcodes and magnetic patterns are also gaining popularity as magnetic security features.

Using a magnetic field for identification is popular as it is an affordable form of a non-visible identification that can be read quickly and reliably. Besides, identification tags which use magnetic fields generally do not require any additional power to function as the magnetic field is an inherent feature of the magnetic materials.

However, means for detecting magnetic fields in the area of security features have been very limited. Most magnetic secured objects, in particular security cards and documents, commonly adopt a detection means which involves sliding the objects' magnetic face into a slot to obtain a magnetic signal. In such swiping applications it is generally necessary to have a physical guide between the item being read and the reader in order to ensure that the track of information being read is the intended track. Also, the mechanical swiping action can gradually wear down both the secured object and the reader sensors or guides, as well as enable debris to become trapped in the guides and scratches to occur on the secured object. If the resolution requires high resolution reading the tracks being read are thin and may require very accurate alignment in order to be read correctly. Nevertheless, increased security often requires the resolution of the magnetic field signal to a fine level. This encourages the development of new high-resolution area detection means with improved usability for users.

An example of a high-resolution detection method is a magneto-optical detection. In the case of magneto-optical discs and similar data storage devices, the magneto-optic detection is achieved by bouncing polarized light off a reflective surface of the magneto-optical disc. The polarization of the reflected light is changed due to the presence of a magnetic field at or around the reflective surface (generally this rotation of the polarization is due to the magneto-optic Kerr effect). By measuring the change in polarization, a detector is able to get a measure of the strength of the magnetic field at the reflective surface. This system works well because of the disc's form factor (flat and round) and the generally benign environments the discs are subjected to. However security labels and markings may be subjected to severe scratching and other harsh conditions during their service life. Therefore in the case of security labels and markings, it is not always practical to use a reading method which requires the substrate being read (for example the label) to contain a flat, clean mirror-finish reflective surface.

Fortunately, alternative devices for magneto-optic detection exist. One solution is to have the reflective surface as a part of the reading device itself, thus reflecting light internally within the device. The reflective surface is brought into close contact with substrate to be read such that the magnetic field from the substrate can influence the light reflected off the reflective surface within the device. This means that the substrate being read is freed from the constraint of having to have a flat mirror surface.

Internally reflective magneto-optical readers have been developed by many groups for use in the field of storage devices, but their usages for identification purposes are very limited. Some examples of magneto-optical readers are detailed below.

U.S. Pat. No. 3,512,866 discloses a magneto-optical hand viewer. The hand viewer is directed specifically to an apparatus constructed to operate using magneto-optical principles for providing a visual representation of magnetic states in a magnetic medium such as a magnetic tape. The hand viewer provides visual representation using the Kerr and Faraday magneto-optical effects. The Kerr magneto-optical effect produces a rotation of the major direction of polarization of the rays of a light beam reflected from a magnetic surface. The Faraday magneto-optical effect produces a rotation of the major direction of polarization of the rays of a light beam passing through a magnetic medium. The magneto-optical hand viewer uses a combination of the Kerr and Faraday magneto-optical effects to provide maximum amplitude of rotation of the rays of the light beam.

U.S. Pat. No. 5,742,036 discloses a method for marking, capturing and decoding machine-readable matrix symbols using magneto-optic imaging techniques. The patent involves enhancing machine-readable matrix symbol markings on substrate materials by the addition of magnetisable materials, and then, at a later time, taking advantage of the magnetic properties associated with the matrix symbol marking to read the marking using a magneto-optic reading apparatus. However, the method described in the patent mainly deals with the detection of Vericode® or other machine readable matrix symbols made by depositing a viscous magnetic compound. In addition, the patent describes the detection of a magnetic anti-counterfeit symbols, but it does not consider magneto-optics for use in non-symbology applications; for example for use imaging the inherent randomness of scattered magnetic particles. In other words, the magneto-optic reader in the patent recognizes symbols written with magnetic particles but does not read individual particles and considers their random position in a fixed area such that the area possesses a non-repeatable pattern in fine resolution.

U.S. Pat. No. 5,920,538 discloses a magneto-optical readout method for reading stored data, a magneto-optical readout head and a method for making the same. The patent describes a magneto-optical readout head for reading magnetically stored data for use with a source of illuminating light having a wavelength. The magnetic-optical readout head comprises an optically transparent substrate having a surface adapted to face a magnetic storage medium, an optically transparent Faraday effect rotator, having a Faraday coefficient θ_{F} disposed on said surface of said substrate and having a Faraday effect rotator surface adapted to face said magnetic storage medium and an optically reflective Kerr effect rotator having a Kerr coefficient θ_{K} disposed on said Faraday rotator surface, with θ_{K} and θ_{F} having a same operational sign at said wavelength of said illuminating light.

In the field of anti-counterfeit technology, it is also found that it is highly advantageous to use combinations of technologies for enhanced protection, for example, reading both magnetic data and optical data. Some examples of combined optical and magnetic transducers are detailed below.

U.S. Pat. No. 3,612,835 discloses a combined optical and magnetic transducer for sensing both optical and magnetic properties of an article, for example, a piece of paper currency or other document having both visible and magnetic markings to be tested or read, an information-bearing medium such as a data-recording tape to be read, or the like. The transducer comprises a magnetic-sensing head having a transparent gap separating the poles of the magnetic core of the head, a photoelectric element being disposed in the head in alignment with the gap. Outside the head, one side of the article contacts or is in close proximity to the poles at the gap, and the article is illuminated by a light source, so that both magnetic properties and optical properties of the article may be detected simultaneously during relative movement of the article and the transducer.

U.S. Pat. No. 3,876,981 discloses a character recognition system and method for recognizing characters printed in magnetic ink in which recognition is enhanced by sensing the characters with both magnetic and optical transducers. At least a signal derived from the magnetic transducer output signal is combined with at least a signal derived from the optical transducer output signal either at or prior to the recognition stage.

U.S. Pat. No. 6,745,942 discloses a magnetic symbology reader having a housing containing a polarized light source which directs light through a magneto-optic sensor onto a reflector which reflects light back through the magneto-optic sensor and then through at least one analyzer and into at least one camera. A view finder allows the user to monitor the image on the magneto-optic sensor as seen by a viewfinder camera while a processor is coupled to possibly a second camera so that when an image is detected, the image from the camera may be processed by the processor to output information associated with the symbol to an external source. The analyzer and polarized light source provide contrast in the images detected by the sensor. A bias or erase coil located about the magneto-optic sensor can enhance or erase images on the sensor.

One of the early usages of magnetically readable identification can be found in U.S. Pat. No. 3,755,730. U.S. Pat. No. 3,755,730 discloses a vehicle, appliance or tool having a multiplicity of magnetisable identifying indicia hidden by an opaque, protective layer such as paint. The indicia may be read by the use of a magnetic reader.

Another example is disclosed in PCT publication number WO 2004/013735. The publication discloses a system and an associated method providing a marking of material to be applied to goods. In one embodiment, magnetic material is applied in a predetermined pattern. An accumulation of magnetic material in one orientation across the structured pattern may provide an automatically sensible value. Magnetically readable material may be provided as a predetermined, repeatable pattern, where the magnetic material is applied to a surface with a resolution in a range of at least 10,000 to 100 dots per inch.

Further prior art on repeatable magnetic pattern on documents and articles of manufacture are described in the following:

U.S. Pat. No. 3,878,367 discloses a security document having a magnetic recording layer containing uniformly dispersed magnetisable material having magnetic anisotropy wherein the material at a plurality of selected locations is differently physically aligned with respect to a reference location to provide a magnetically detectable permanent fixed information pattern such as a code pattern useful for authenticating the document.

U.S. Pat. No. 4,081,132 discloses a security document having a carrier and two layers of magnetisable material, one overlying the other, the carrier and layers being all bonded together. One layer is for the recording of information and the other layer has a magnetic structure which can be examined for verification purposes. The patent discloses that a preferred method of making the structured layer is to deposit magnetisable material to form the layer within the influence of a magnetic field from a recording on the information layer which is of the form of the structure. The recording is erased when the structured layer has been formed. The security document may be a credit card, a bank note or other valuable paper.

U.S. Pat. No. 3,803,634 discloses an apparatus and a method for magnetic printing in which one or more perforations are formed in a base plate of a master magnetic medium for magnetic pattern printing, and one or more magnetizing elements formed illustratively of permanent magnets are disposed in the perforations with their end faces projecting a small distance from the surface of the base plate. The surface of a magnetic film of a slave magnetic medium for copying is contacted closely with the end faces of the magnetizing elements, and an external magnetic field is impressed to the contacted portions. The desired magnetic patterns are formed by the arrangement of the magnetizing elements or by the relative movement of said magnetizing elements with respect to the slave magnetic medium for copying; as a result, said magnetic patterns are copied on the magnetic film of the slave magnetic medium.

U.S. Pat. No. 4,183,989 discloses a security paper which contains a security device e.g. a strip, thread or planchette having at least two machine verifiable security features thereon, one of which is a magnetic material, which may be magnetically coded or printed in a predetermined pattern on the device, and a second of which is a luminescent material, an X-ray absorbent or a metal. The provision of several features on one device provides a large increase in document security.

U.S. Pat. No. 3,701,165 discloses garments which are formed with marks or stitching which carry a substance detectable by magnetic detecting devices. When the magnetized substance on the garment part is detected in a process of making garments, subsequent garment making steps are actuated in response to the detection of the stitching.

U.S. Pat. No. 4,180,207 discloses a secure document that is produced by securely attaching to a support, a body including a security feature and having a shape which conveys information to the eye. For example the body is a layer of magnetisable material having apertures of letters, numbers and the like. The document can be examined by both magnetic and optical examination apparatus to cross-check that no alteration has been made. A method of making a secure document and examination apparatus is also described. The security feature may be a pattern of magnetic anisotropy fixed into the material.

U.S. Pat. No. 3,755,730 discloses a vehicle, appliance or tool having a multiplicity of magnetisable identifying indicia hidden by an opaque, protective layer such as paint. The indicia may be read by the use of a magnetic reader.

In creating the preferred anti-counterfeit magnetic fingerprints, magnetic particles need to be aligned in a particular manner to give distinguishable signals. One approach is disclosed in United States Patent Application Number 20060081151. The patent application discloses a method and apparatus for printing using paste like inks such as those used in intaglio printing, wherein the inks include specialty flakes such as thin film optically variable flakes, or diffractive flakes. The patent application also discloses an apparatus having an energy source such as a heat source for temporarily lessening the viscosity of the ink during alignment of the flakes within the ink.

A similar method can also be found in U.S. Pat. No. 7,047,883. U.S. Pat. No. 7,047,883 discloses an apparatus and related methods to align magnetic flakes in a carrier, such as an ink vehicle or a paint vehicle to create optically variable images in a high-speed, linear printing operation. Images can provide security features on high-value documents, such as bank notes. Magnetic flakes in the ink are aligned using magnets in a linear printing operation. Selected orientation of the magnetic pigment flakes can achieve a variety of illusive optical effects that are useful for decorative or security applications.

However there is still a need for a reading device, system and method for identifying tags or objects adapted to be identified which provides sufficient security of verification, i.e. in which the reliability of the identification is sufficiently high.

It is an objective of the present invention to provide such a reading device, system, and method. This objective, and others, is solved by the reading device, method and system as defined by the respective independent claims.

### SUMMARY OF THE INVENTION

In an embodiment of the invention, a reading device able to read magnetic and optical information is provided. The reading device includes a reading element, the reading element comprising a magneto-optical substrate adapted to read overlapping magnetic identification features and optical identification features, wherein the magneto-optical substrate is at least partially transparent. Note that herein where the prepositions “in” or “on” are used to describe the location of identification features with respect to a tag or an object we also consider the use of the other preposition (for example “in a tag” should also be considered to be “on a tag” and vice versa). The reading device is configured such that a first signal generated from reading the first set of identification features and a second signal generated from reading the second set of identification features are independently used to derive a first signature and a second signature for identifying the tag or object.

In a further embodiment, the magneto-optical substrate comprises a layer arrangement, the layer arrangement includes: an optically transparent substrate, a first coating layer and a second coating layer. The magneto-optical substrate further comprises a protective layer.

In a further embodiment, the second coating layer is partially transparent and partially reflective. The second coating layer may reflect at least a portion of light, wherein the light is monochromatic. Herein a “monochromatic” light source refers not only to a strictly monochromatic (i.e. one colour) light source but is also considered to include any light source which is not white (i.e. sources which substantially exclude at least one colour or band of wavelengths) and which emits electromagnetic radiation within a defined wavelength range, for example a light source which emits light of a wavelength of between 450 nm and 495 nm is usually considered to be a monochromatic blue light source, whereas a monochromatic green light source is usually considered to emit between 495 nm and 570 nm. In line with this definition of being monochromatic when emitting radiation within a (pre)defined wavelength range, for example, cyan light which consists of blue and green and which is emitted by a light source in the range of between 450 nm and 570 nm is also considered to be a monochromatic light. As another example herein the term “monochromatic” is not confined to classical spectral colours but also includes any kind of suitable predefined wavelength range, for example 600 nm-750 nm is considered herein to be a “monochromatic” light source. The second coating layer may comprise a dichroic mirror or a dielectric mirror. The second coating layer may also be configured to change its reflective property. In one embodiment, the second coating layer is a switchable mirror.

In a further embodiment, the second coating layer comprises at least two regions, a first region for reading the optical identification features and a second region for reading the magnetic identification features, wherein the patterned second coating layer comprises a plurality of first and second regions arranged in an array of alternating first and second regions.

In a further embodiment, the reading device is configured to generate an alternating current to induce a magnetic field with the magnetic identification features. In a further embodiment, the reading device comprises one or more magnets (these magnets could be, for example, permanent magnets or solenoid magnets) configured to generate a magnetic field in the region of the magnetic identification features.

In a further embodiment, the reading device comprises one or more light sources configured to generate at least two monochromatic light signals, at least one of the two monochromatic light signals being of a wavelength capable of producing an image of the optical identification features and at least one other being of a wavelength capable of producing an image of the magnetic identification features. One of the at least two monochromatic signals may pass through a polarizer. Herein “a wavelength” is not strictly limited to one single wavelength of light; instead it is understood to also include a range of wavelengths as appropriate (for example, “a wavelength” can also refer to the range of wavelengths from 620 nm-750 nm). Herein words such as “polarized” and “polarizers” generally refer to linear polarization, but also include other forms of polarization such as circular polarization where applicable.

In a further embodiment, the reading element comprises an engagement element for positioning the magneto-optical substrate over an area of the first set of identification features. The engagement element substantially surrounds the magneto-optical substrate. The engagement element is essentially complementary in shape to an engagement track in the tag or object thereby forming an interlocking means. The engagement element may be formed as a cavity or recess and the recess has a height of at least about 50 micrometers, at least about 150 micrometers, of at least about 200 micrometers or at least 250 micrometers. The engagement element may also be formed as a protrusion. The protrusion has a height of at least about 50 micrometers, at least about 150 micrometers, of at least about 200 micrometers or at least 250 micrometers. The engagement element has in cross-section a circular shape or a polygonal cross-sectional shape.

In a further embodiment, at least the reading element is adapted to conform to the tag or object to be identified when brought into contact with the tag or object to be identified. The reading element comprises a conformation element facilitating at least the reading element to conform to the tag or object to be identified when the reading element is brought into contact with the tag or object to be identified. The conformation element comprises at least one spring, a sponge, a suction system, a hydraulic system, a pneumatic system. The conformation element pushes at least the reading element against an area to be read during reading and the conformation element is adapted to protect the surface of the reading element from being damaged if the reading device is dropped or is brought against a hard surface. The conformation element is also designed to allow the reading element to sink below the level of the engagement element if the reading element is pushed. The reading element is housed below the level of the engagement element when not in use but when engaged with the tag or object to be read, the engagement element pushes the reading element onto the surface of the area to be read. At least the reading element is distanced from the engagement element allowing the reading element to conform to the tag or object to be identified when brought into contact with the tag or object to be identified.

In a second embodiment of the invention, a reading device for reading magnetic and optical information is provided. The reading device includes a reading element comprising a magneto-optical substrate, the magneto-optical substrate includes a reflective layer configured to reflect a first portion of light, and a transparent layer configured to pass through a second portion of light, wherein the reflective layer and the transparent layer overlap to form an overlap region, the overlap region being capable of reading both magnetic and optical information of an object.

In a third embodiment of the invention, a reading device for identifying a tag or an object adapted to be identified is disclosed. The reading device includes a reading element for reading a first set of identification feature located in the tag or the object adapted to be identified, wherein the reading element is a magneto-optical reading element, the magneto-optical reading element at least one magneto-optical substrate. The reading element includes an engagement element for positioning the reading element over an area of the first set of identification features wherein the engagement element substantially surrounds the reading element and the engagement element is essentially complementary in shape to an engagement track in the tag or object adapted to be identified, thereby forming an interlocking means. The engagement element is formed as a recess or protrusion.

In a fourth embodiment of the invention, a method of identifying a tag or an object adapted to be identified is disclosed. The method includes generating a first signal from a magneto-optical reading of a first set of identification features located in the tag or object adapted to be identified only, wherein a first set of identification features comprises a disordered arrangement of magnetic or magnetisable particles included in an identification layer of the tag or object. The first signal generated from reading the first set of identification features as such is used to derive a first signature for identifying the tag or object. The method also includes generating a second signal from reading a second set of identification features, wherein the second set of identification feature comprises optical identification features, and the first set of identification features and the second set of identification features may at least partially overlap.

In a further embodiment, the disordered arrangement of magnetic or magnetisable particles comprises a plurality of randomly distributed magnetic or magnetisable particles. The magnetic particles comprise a ferrimagnetic material, an antiferromagnetic material, a ferromagnetic material or domains of varying magnetic properties within a continuous material (including voids causing variable magnetic properties) and combinations thereof. The ferromagnetic material is selected from the group consisting of MnBi, CrTe, EuO, CrO₂, MnAs, Fe, Ni, Co, Gd, Dy, Nd corresponding alloys and oxides of Fe, Ni, Co, Sm, Gd, Dy, and combinations thereof. An exemplary high coercivity material is a neodymium magnet comprising Nd, Fe and B.

In a further embodiment, the method further comprises generating a second signal from reading a second set of identification features. The first signal generated from reading the first set of identification features and the second signal generated from reading the second set of identification features are independently used to derive a first signature and a second signature for identifying the tag or object. The second set of identification features comprises a chip, a magnetic strip, a serial number, or an optical marking. The chip is a radio frequency identification tag or a contact-based memory chip. The optical marking is a linear barcode, 2D barcode (such as PDF416 standard), matrix barcode (such as a DataMatrix, QR code and other open source or proprietary patterns that represent numeric or alphanumeric sequences) or a hologram. The optical marking may not be visible to the naked human eye, but detectable in the ultraviolet or infrared regime of the electromagnetic spectrum.

In a further embodiment, the first set of identification features and the second set of identification features are located within an engagement track in the tag or object adapted to be identified. The first set of identification features and the second set of identification features may be on the same plane. Alternatively, the first set of identification features and the second set of identification features may be on different planes.

In a fifth embodiment of the invention, a method of identifying a tag or an object adapted to be identified is disclosed. The method includes generating a first signal from magneto-optical reading of a first set of identification features located in the tag or the object adapted to be identified, generating a second signal from reading a second set of identification features located in the tag or the object adapted to be identified, wherein the first signal generated from reading the first set of identification features and the second signal generated from reading the second set of identification features are used to derive a first signature and a second signature for identifying the tag or the object.

In one embodiment, the first set of identification features comprises a disordered arrangement of magnetic or magnetisable particles. The disordered arrangement of magnetic or magnetisable particles comprises a plurality of randomly distributed magnetic or magnetisable particles. The magnetic particles comprise a ferrimagnetic material, an antiferromagnetic material, a ferromagnetic material or domains of varying magnetic properties within a continuous material (including voids causing variable magnetic properties) and combinations thereof. The ferromagnetic material is selected from the group consisting of MnBi, CrTe, EuO, CrO₂, MnAs, Fe, Ni, Co, Gd, Dy, corresponding alloys and oxides of Fe, Ni, Co, Sm, Gd, Dy, and combinations thereof. An exemplary high coercivity material is a neodymium magnet comprising Nd, Fe and B.

In a further embodiment, the first set of identification features and the second set of identification features are located within an engagement track in the tag or object adapted to be identified. The first set of identification features and the second set of identification features may be on the same plane. Alternatively, the first set of identification features and the second set of identification features may be on different planes.

In a sixth embodiment of the invention, an identification system for identifying a tag or an object adapted to be identified is disclosed. The system includes a tag for identifying an object to which the tag may be attached and a reading device for reading at least a first and second set of identification features located in the tag or object adapted to be identified.

In one embodiment, the first signal obtained from the reading element is normalized against a signal obtained from the same reading element in the absence of a substantial magnetic field. The normalization is achieved by subtracting the signal obtained from the reading element in the absence of a substantial magnetic field from the signal obtained from the reading element when engaged with the area to be read. The normalization further comprises identifying portions of data in the signal being read which may be less reliable than the other data because of damage or variations within the reading element, said less reliable data being processed differently to the other data.

In a further embodiment, the first signal obtained from the reading element is processed by setting all data in the signal which is below a predefined threshold to a predefined value or by ignoring the data and only storing data (including the physical positioning of the data) that is above the predefined threshold.

In a further embodiment, the identification system further comprises a data storage medium in which a reference signature obtained from a reference reading of the identification tag is stored. The data storage medium for the pre-stored reference signature is a data storage medium remote with respect to the reading device, or the data storage medium may be within the reading device itself. The data storage medium for the pre-stored reference signature may be located in the tag which is attached to the object. Alternatively, the data storage medium for the pre-stored reference signature may be located in the object. The data storage medium is a magnetic strip, a memory chip, a media disk, a hard disk, a smart-card, a RAM module, a magnetic tape or conventional optical means such as a 2D barcode or bitmap.

In a further embodiment, the identification system further comprises a data processing device remote with respect to the reading device, wherein the data processing device is adapted to perform the data processing in order to match the read signature with the pre-stored reference signature. In this embodiment the data storage medium may be located with, or be the same as, the remote data processing device.

In a further embodiment the reading device is used to obtain information about any item which emits or can be made to emit a magnetic field. For example, magnetic fields can be used to obtain information about crack or other flaws (e.g. inclusions and voids) in structural objects or in electronic devices for example where electrical currents produce localized magnetic fields—a practical example would be non-destructive testing of electronic circuits.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an anti-counterfeit system utilizing a reading device in accordance with an embodiment of the invention;

FIG. 2 shows a flow-chart illustrating an authentication process using the reading device in accordance with an embodiment of the invention;

FIG. 3 shows a reading device in accordance with an embodiment of the invention;

FIG. 4 shows a cross-sectional view of a suitable reading element based on prior art;

FIG. 5A and FIG. 5B respectively shows a top view and a perspective view of magnetic particles used in a tag in accordance with an embodiment of the invention;

FIG. 6A and FIG. 6B show different densities of magnetic particles used in a tag in accordance with an embodiment of the invention;

FIG. 7A and FIG. 7B show further examples of tags with identification features in accordance with an embodiment of the invention;

FIG. 8A to FIG. 8E shows a cross-sectional view of a tag where the magnetic information and optical information overlap;

FIG. 9 shows a cross-sectional view of a reading element in accordance with another embodiment of the invention;

FIG. 10A shows a scan area of a tag with optical barcode and magnetic particles where the reading element is a gray scale optical detector; FIG. 10B shows a scan area of a tag with a blue green barcode and magnetic particles where the reading element is as shown in FIG. 9;

FIG. 11A shows a reading device where red light is being transmitted through the second coating layer and through the protective layer in accordance with an embodiment of the invention; FIG. 11B shows the reading device of FIG. 11A where green light is being reflected by the second coating layer in accordance with an embodiment of the invention;

FIG. 12A shows a top view of a tag with optical and magnetic features artificially superposed in accordance with an embodiment of the invention; FIG. 12B shows a red-spectrum image of the tag taken using a reading element in accordance with an embodiment of the invention; FIG. 12C shows a green-spectrum image of the tag taken using a reading element in accordance with an embodiment of the invention;

FIG. 13A shows a top view of a tag with optical and magnetic features artificially superposed; FIG. 13B shows a configuration of an imaging area of a tag taken using a reading element in accordance with an embodiment of the invention; FIG. 13C shows optical tag information from an image of the tag taken using the reading element in accordance with an embodiment of the invention; FIG. 13D shows magnetic tag information from an image of the tag taken using the reading element in accordance with an embodiment of the invention;

FIG. 14A shows an optical top view of a tag that is being produced in accordance with an embodiment of the invention; FIG. 14B shows a magnetic top view of a tag that is being produced in accordance with an embodiment of the invention; FIG. 14C shows a configuration of a reading element which may be used to read the optical and magnetic information on the tag in accordance with an embodiment of the invention; FIG. 14D shows an image of the tag taken using the reading element of FIG. 14C in accordance with an embodiment of the invention;

FIG. 15A shows a grid pattern in accordance with an embodiment of the invention; FIG. 15B shows a datamatrix code in accordance with an embodiment of the invention; FIG. 15C shows a superposition of the grid pattern from FIG. 15A and the datamatrix code from FIG. 15B in accordance with an embodiment of the invention;

FIG. 16A shows an optical top view of a tag that is being produced in accordance with an embodiment of the invention; FIG. 16B shows a magnetic top view of a tag that is being produced in accordance with an embodiment of the invention (the grid pattern associated with the optical datamatrix code is artificially superposed over the magnetic view; FIG. 16C shows a configuration of a reading element which may be used to read the optical and magnetic information on the tag in accordance with an embodiment of the invention; FIG. 16D shows an image of the tag taken using the reading element of FIG. 16C in accordance with an embodiment of the invention;

FIG. 17 shows an optical and magnetic reading of a tag in accordance with an embodiment of the invention;

FIG. 18A shows a cross-sectional view of a reading element in accordance with an embodiment of the invention; FIG. 18B shows direction of light travelling centrally within the reading element in accordance with an embodiment of the invention; FIG. 18C shows light being reflected from different areas of the magneto-optical substrate in accordance with an embodiment of the invention;

FIG. 19A shows a cross-sectional view of a reading element in accordance with an embodiment of the invention; FIG. 19B shows light travelling from a light source within the reading element and being reflected from different areas of the magneto-optical substrate in accordance with an embodiment of the invention; FIG. 19C shows a cross-sectional view of a reading element in accordance with another embodiment of the invention

FIG. 20A to 20D is a simplified graphical representation of some components of a reading element and their interaction with two sets of polarized light in accordance with an embodiment of the invention;

FIG. 21A shows a top view of a tag with optical and magnetic features artificially superposed in accordance with an embodiment of the invention; FIG. 21B shows a green-spectrum image of the tag taken using a reading element in accordance with an embodiment of the invention; FIG. 21C shows a red-spectrum image of the tag taken using a reading element in accordance with an embodiment of the invention.

FIG. 22 shows a method of reading a tag on a level surface using a magneto-optical reading element in accordance with an embodiment of the invention;

FIG. 23 shows a magneto-optical reading element and a tag in accordance with an embodiment of the invention;

FIG. 24 shows a method of reading a tag on a level surface using a magneto-optical reading element in accordance with another embodiment of the invention;

FIG. 25A to 25D shows a method of reading a tag on an uneven surface using a magneto-optical reading element conforming to the tag surface in accordance with another embodiment of the invention;

FIG. 26 shows a method of reading a fingerprint contained in a compliant label using a magneto-optical reading element in accordance with an embodiment of the invention;

FIG. 27 shows how a compliant label can assist when an item of value to which the label is affixed, has a rough surface in accordance with an embodiment of the invention;

FIG. 28 shows a further compliant label formation in accordance with an embodiment of the invention;

FIG. 29A shows a cross-sectional view of a tag containing a fingerprint region in accordance with an embodiment of the invention; FIG. 29B shows a plan view of a tag and a fingerprint region in accordance with an embodiment of the invention;

FIG. 30A shows a situation prior to engaging a magneto-optical reading element with a thick label in accordance with an embodiment of the invention; FIG. 30B shows a magneto-optical reading element being compressed against a thick label when reading a tag in accordance with an embodiment of the invention;

FIG. 31 shows a method of reading a label with an alignment feature using a magneto-optical reading element in accordance with an embodiment of the invention;

FIG. 32 shows a method of reading a tag containing a fingerprint in accordance with an embodiment of the invention; and

FIG. 33 shows a tag in a groove of an object to be identified in accordance with an embodiment of the invention.

### DESCRIPTION

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

In an embodiment of the invention, a reading device is provided that is able to obtain information from individual magnetic particles and considers for example their random position in a fixed area such that the area possesses a unique pattern in fine resolution.

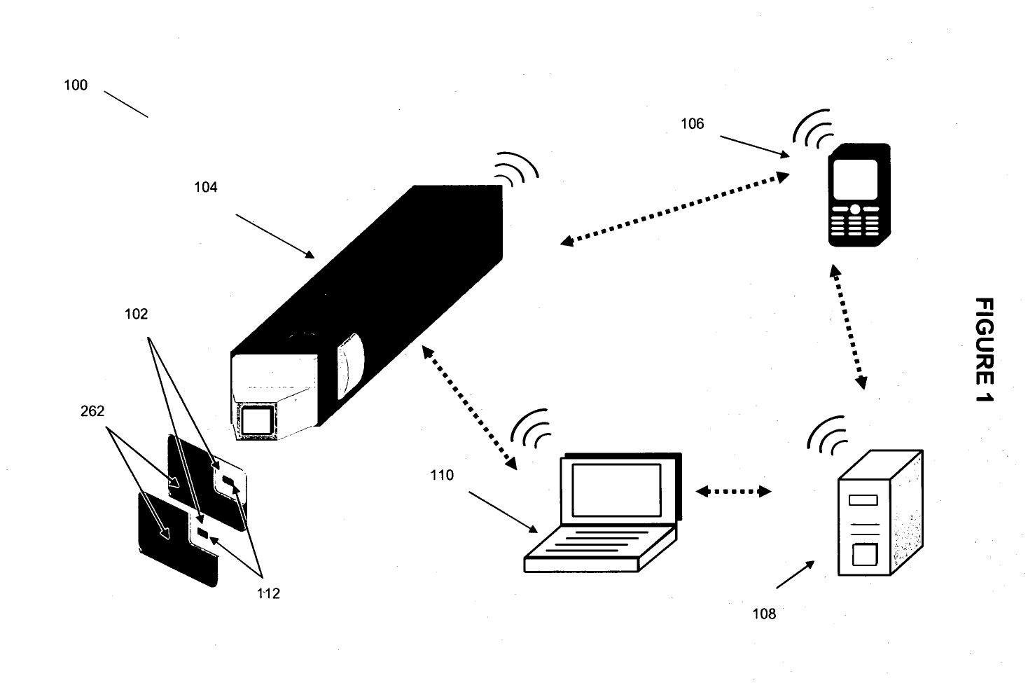

FIG. 1 shows an anti-counterfeit system 100 utilizing a reading device 104 in accordance with an embodiment of the invention. Note that although the system 100 shown here shows a basic reading device 104 communicating with a data server 108 via a mobile device 106 (such as a mobile phone) or a computer 110, it is also contemplated that the reading device 104 may itself be more elaborate and may, for example, communicate to a database or data server 108 via methods such as using data cables, local area networks, Bluetooth, Wi-Fi, Worldwide Interoperability for Microwave Access (WiMAX) technology, or even including using a built in General Packet Radio Service (GPRS) chip or 3G/Universal Mobile Telecommunication System (UMTS) chip to itself act as a mobile telephonic device to communicate to the data server 108. The reading device 104 may also include methods for direct communication with the user, for example a screen and a keyboard which may allow the user to read and enter information on the reading device 104 itself. The anti-counterfeit system 100 may include at least one tag 102, a reading device 104, a mobile device 106 or a computer 110 (if no direct communication means between the reading device 104 and data server 108 exists), and a remote data server 108. Each tag 102 comprises at least one set of identification features. Some examples of identification features include a disordered array of magnetic or magnetisable particles, a magnetic strip, a serial number, an optical marking such as a bar-code or a hologram.

The identification features as shown in FIG. 1 includes a disordered array of magnetic or magnetisable particles forming a magnetic fingerprint region 112. Each tag 102 is attached to an object or an item of value 262 to be identified or adapted to be identified. The reading device 104 is used for reading at least one set of identification features on the tag 102. The reading device 104 has the capability to send a signal generated from reading the set of identification features to the mobile device 106 or the computer 110. Encrypted signals from the reading device 104 can be sent out to the mobile device 106 or the computer 110 either through a wireless connection or a wired connection. Some examples of wireless connection include Bluetooth and Wi-Fi and some examples of wired connection include Recommended Standard 232 (RS232) and Universal Serial Bus (USB). The computer 110 can be a personal computer, a workstation a laptop or palmtop. The mobile device 106 can be a mobile (cellular) phone or a personal digital assistant (PDA) for example. The mobile device 106 or the computer 110 can connect to a data server 108 which may be a remote data server (or which may be linked to the remote server), via the internet. The mobile device 106 connects via a local network using General Packet Radio Service (GPRS) or 3G/UTMS technology, for example.

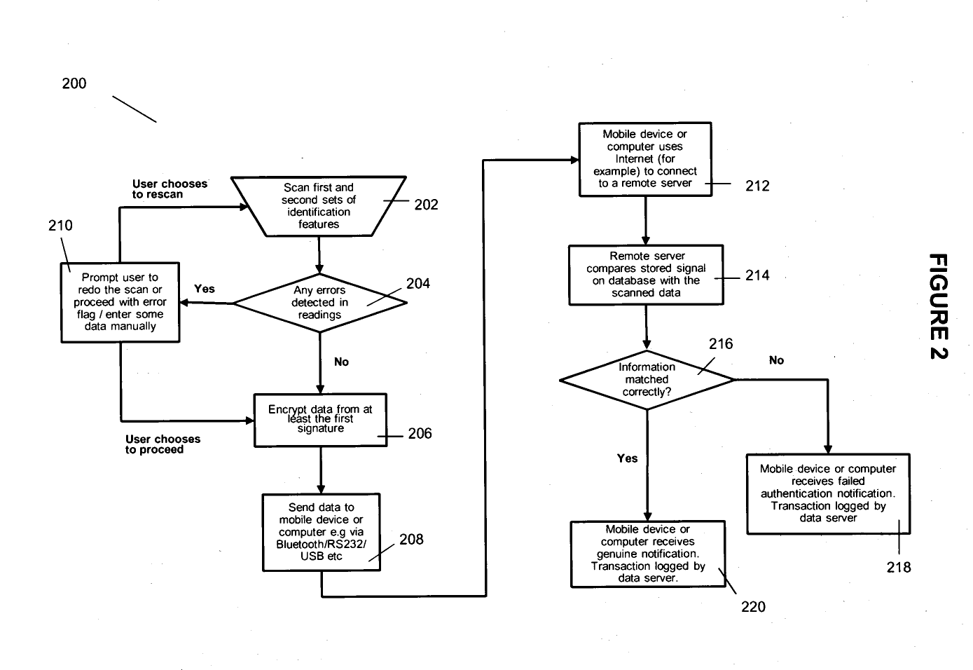

FIG. 2 shows a flow-chart 200 illustrating an authentication process using the reading device 104 in accordance with an embodiment of the invention. Firstly in 202, a reading device 104 is used to scan a first set of identification features and a second set of identification features. The scanning of the first set of identification features and the second set of identification features may be performed in a single step or in two steps. The first set of identification features may include magnetic information such as a magnetic fingerprint region 112 and the second set of identification features may include optical information such as a linear barcode, 2D barcode, or matrix barcode such as a datamatrix (all such types of barcodes being referred to generally as a barcode herein). The scanning of the first set of identification features and the second set of identification features takes into account the relative position of the first set of identification features in relation to the second set of identification features. Although this example describes a first set of features being magnetic and a second set of features being optical in nature, the order of reading or the type of features present in each respective set may be interchanged.

At 204, the reading device 104 checks the read signals to see if any errors can be detected in the readings. If the reading device 104 detects errors, in 210, it provides a prompt to the user to choose to either redo the scan of the first set of identification features and the second set of identification features or (in the case the error is not fatal) to proceed with the error flag and data transmission. If the user chooses to continue with the data transmission, the user may for example also be prompted to manually enter some of the data using the mobile device or computer keyboard (for example if a barcode is misread, the user may opt to type the barcode number in rather than rescan). Thereafter, in 206, at least the signals or data generated from reading the first set of identification features (i.e. magnetic fingerprint region 112) are encrypted. Optionally, the signals or data generated from reading the second set of identification features are also encrypted. However, it is also encompassed in the present invention to encrypt the machine readable signal using a different algorithm or key to that which may encrypt the human readable identification features. This helps to protect the encryption from being compromised. In 208, the at least partially encrypted data are sent to a mobile device 106 or a computer 110 via a wired or a wireless connection. In 212, the mobile device 106 connects to a remote data server 108 via the internet using, for example, GPRS or the computer 110 connects to the remote server 108 through an internet connection.

In 214, the remote server 108 compares a stored signal (from a prior scan of the magnetic fingerprint region and/or the optical information) on a database with the scanned signal from the magnetic fingerprint region. In 216, the server determines if the stored signal and the scanned signal can be matched (here a matching threshold is used to determine if the data matches to an adequate degree of certainty or not). If the respective signals do not match, in 218, a failed authentication notification is sent to the mobile device 106 or computer 110. If the information matches, in 220, the mobile device 106 or computer 110 receives a successfully matched notification. This notification may also be accompanied by additional information about the tag or object that may be of use to the user. Note that as in FIG. 1, it is contemplated that the reading device 104 may be more elaborate and may itself be able to communicate with the remote data server 108 without the peripheral mobile device or computer. This more elaborate reading device 104 may include a keyboard and display screen for direct communication with the user. Note further that the term “signal” or “signals” refer to the data read from identification features—therefore a signal may, for example, be an image representing the magnetic features of the fingerprint region.

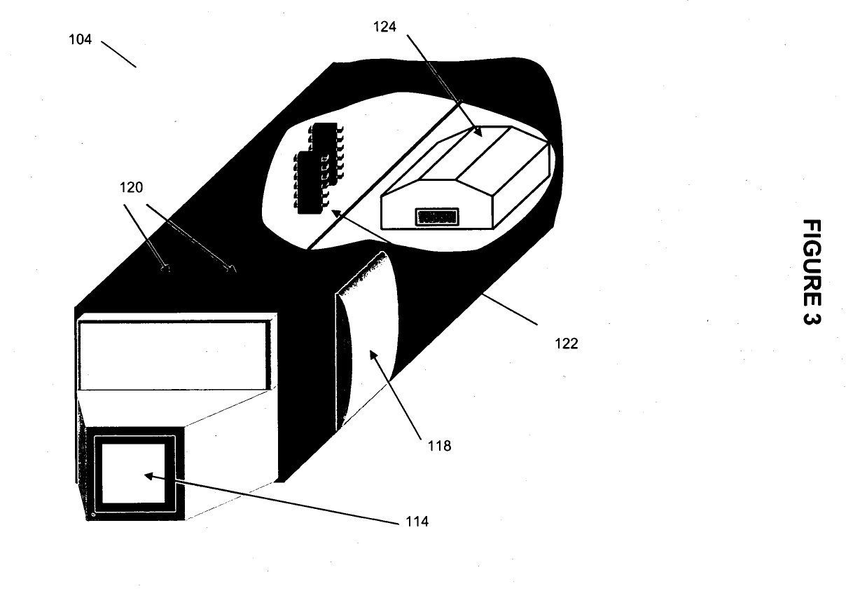

FIG. 3 shows a reading device 104 in accordance with an embodiment of the invention. The reading device 104 includes a reading element 114, a switch 118, two light-emitting diode (LED) indicators 120, two microcontroller chips 122, a portable power source 124 and communication electronics and software (for example a Bluetooth module, Wi-Fi module, USB module or RS232 module). The reading element 114 is used for reading a first set of identification features on a tag 102. The reading element 114 may read both magnetic and optical identification features. The switch 118 is used for activating or deactivating the reading device 104 and may be positioned at any suitable position (for example an ergonomic) on the reading device 104. The LED indicator 120 provides an indication of the status of the reading device 104, for example, if it is on, reading data, transmitting data, or encountered an error. Each microcontroller chip 122 is a single integrated circuit, including a processing unit, input and output interfaces, a serial communication interface, a storage device for example. The number of required microcontroller chips 122 or LED indicators 120 depends on the requirements of the reading device 104. The portable power source 124 is typically a disposable battery or a rechargeable battery for example (but if communication means such as USB are used, the reading device 104 may be powered via the USB cable).

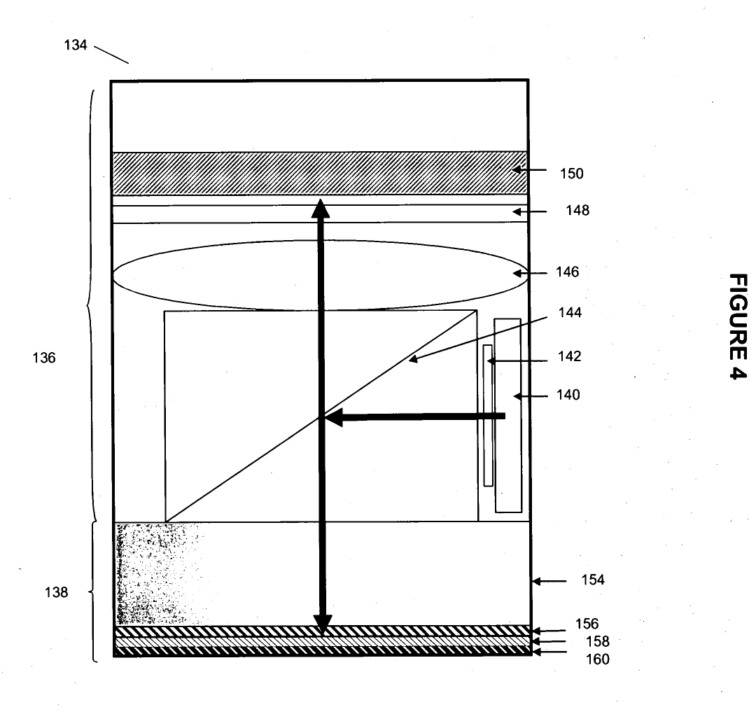

FIG. 4 shows a cross-sectional view of a reading element 134 based on prior art. The reading element 134 in FIG. 4 includes an optical processing unit 136 and a magneto-optical substrate 138. The optical processing unit 136 includes a plurality of components, the components including a light source 140, two polarizers 142, 148, (if the light source does not emit polarized light, then two polarizers as shown, may be necessary, or it is in certain circumstances possible to use one polarizer combined with a polarizing beam splitter for example) a beam splitter 144, a lens system 146 (although just one lens is shown in the FIG. 4, it will be apparent to anyone skilled in the art that, in general, a series of lens elements may be needed to achieve a good quality image) and an optical detector 150 (for example a charge-coupled device (CCD), or a complementary metal-oxide-semiconductor (CMOS) chip which is able to take an image). Note that the configurations shown and described in relation to FIGS. 4, 9, 11, 18 and 19 are merely for illustration and the exact configuration can vary; for example the positioning of the polarizer 148 and the lens system 146 can be interchanged or the polarizer 148 can be placed in between the lens system 146. Further, some of the lenses within the lens system 146 may be positioned in front of the beam splitter 144 or that the beam splitter 144 may be within the series of lens within the lens system 146.

The magneto-optical substrate 138 comprises an optically transparent substrate 154 and a plurality of magneto-optic coatings such as a first coating layer 156, a second coating layer 158 and a protective layer 160. Various suitable arrangements are possible, for example, as disclosed in U.S. Pat. No. 5,920,538, the optically transparent substrate 154 can be a mono-crystalline garnet (such as a gadolinium gallium garnet which may further contain other components such as scandium), the first coating layer or magneto-optic film 156 may be a Faraday rotator (comprising, for example, a ferrite-garnet film), the second coating layer or reflective layer 158 can be a Kerr rotator (comprising, for example, gadolinium ferrite), the second coating layer 158 may be further coated with a reflective or transparent protective layer 160.

The light source 140 may be a polarized source or a non-polarized source. Some examples of a polarized source include certain types of lasers, and some examples of a non-polarized light source include a light emitting diode (LED). Further, the light source 140 may be monochromatic, although other options such as a white light source may also be suitable. Light from the light source 140 passes through a first polarizer 142 and is then incident on the beam splitter 144. A significant proportion of the light is reflected by the beam splitter 144 towards the magneto-optical substrate 138. This light is reflected by one or more of the magneto-optic coatings 156, 158 and 160 and travels back towards the beam splitter 144. A significant proportion of the light passes through the beam splitter 144, travels through the lens system 146 and the second polarizer 148 before it reaches the optical detector 150 which captures an image representative of the magnetic fields present at the magneto-optic coating layers 156, 158, 160. Note that although in FIGS. 4, 9, 11, 18 and 19 the light path is generally represented by a single arrow (or a few arrows/lines), this is not intended to imply that the light only travels along that single path, generally the light may be over an area wide enough to image the desired area of the magneto-optic substrate 138. Note further that the second polarizer 148 is rotated with respect to the polarization of the incoming light (in FIG. 4 the “polarization of the incoming light” means the polarization immediately after the light has passed through the first polarizer 142). The second polarizer 148 may be tuned with respect to the polarization of the incoming light (or vice versa) to ensure the maximum image contrast depending on the magnetic fields being measured. Note that when a polarized source is used, only one polarizer is needed. All images herein are not to scale. For example, the magneto-optical substrate shown in FIG. 4 (and other figures) is often thickened with the rest of the figure in order to allow clear demarcation of the various coating layers.

The protective layer 160 serves to protect the first coating layer or magneto-optic film 156 and the second coating layer or reflective layer 158 from any damage. The protective layer 160 is preferentially a hard thin coating such as diamond like carbon (DLC) or tetrahedral amorphous carbon (ta-C), or it may be transparent such as aluminium oxide (Al₂O₃) but not so limited. The thickness of the protective layer 160 is in the range of a few nanometers to a few microns, depending on the chosen material and its internal stresses, but not so limited.

The components in the optical processing unit 136 and the layer arrangement in the magneto-optical substrate 138 may have a fixed spatial relationship with respect to each other. By this we mean that it is preferable that at least the main optical components (for example the optical detector 150, the lens system 146, the polarizers 142, 148, the beam splitter 144 and the magneto-optical substrate 138) are all fixed with respect to each other such that they may be considered as forming a solid unit or module, i.e. the reading element, 134. Note that the reading element 134 utilizes magneto-optical reading of the tag 102 wherein light is internally reflected inside the reading element 134 by magneto-optical substrate 138. This means that the light being used to analyze the magnetic fields does not reflect off the surface of the tag 102.

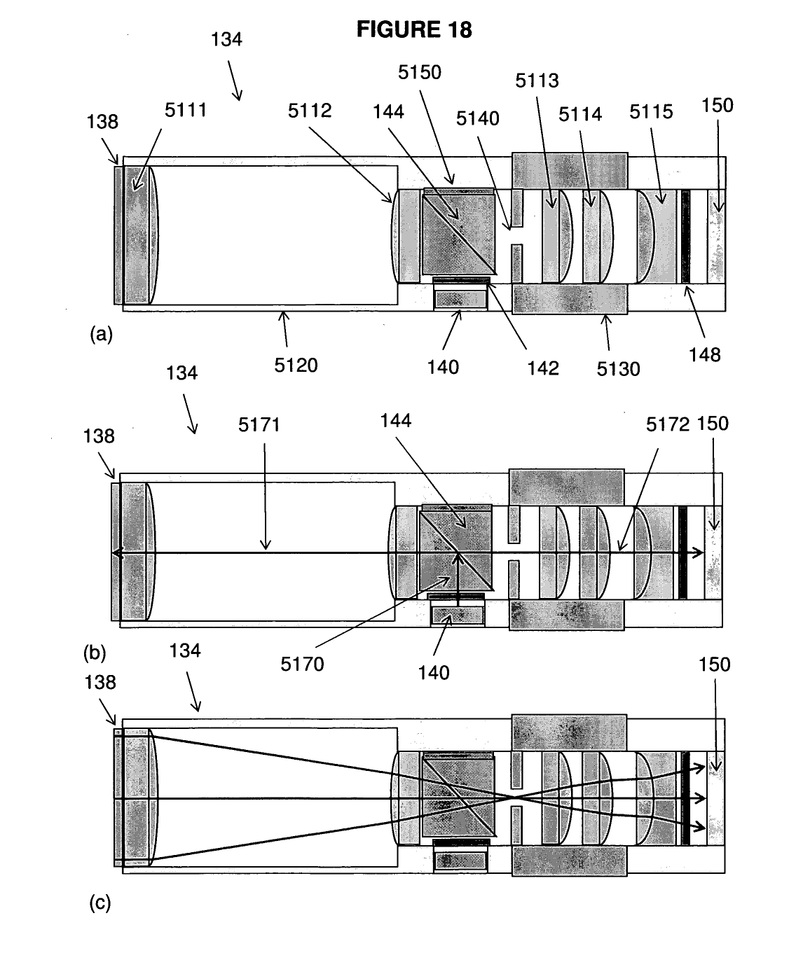

Because the magneto-optical substrate 138 allows little to no light to pass through, optical information located on the surface of tag 102 cannot be read. Thus, reading element 134 is also not capable of producing a combined signal of optical and magnetic information if optical and magnetic information are located in the same area (i.e., overlapping) of tag 102. A reading element comprising a magneto-optical substrate configured to read both optical and magnetic information is within the scope of the invention and is further discussed, for example, in the description of FIGS. 18, 19, and 20.

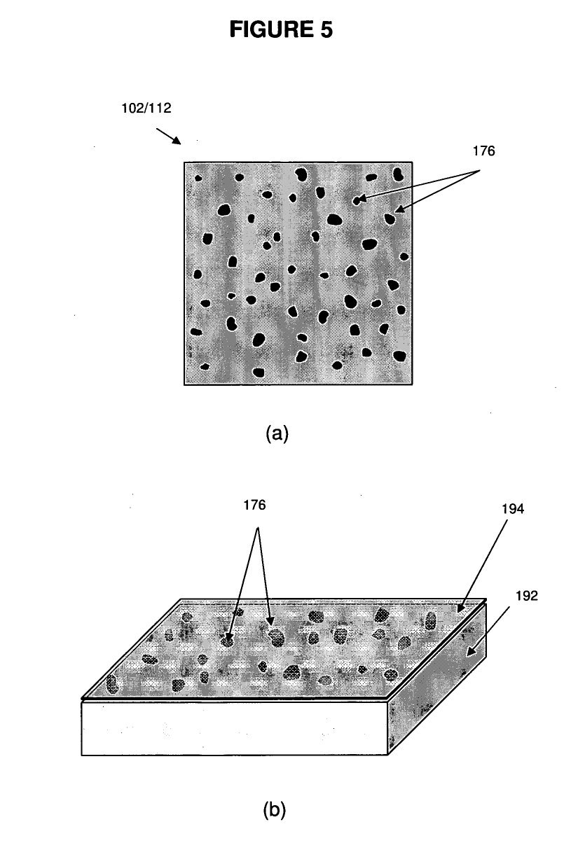

FIG. 5A and FIG. 5B respectively show a top view and a perspective view of magnetic particles 176 (preferably of high magnetic coercivity) used in a tag 102 in accordance with an embodiment of the invention. To obtain a clear magneto-optical signal, particles 176 of high coercivity magnetic materials forming the magnetic fingerprint region 112 should be used. FIG. 5B shows that in this embodiment, the magnetic particles 176 form a layer sandwiched between a base layer 192 and a cover layer 194. The base layer 192 and cover layer 194 are generally formed from films of material, with the base layer 192 providing a support for the magnetic particles 176 and the cover layer 194 providing protection from the environment and from abrasion. The maximum thickness of the cover layer 194 that can be used is dependent on the strength of the magnetic fields produced by the magnetic particles 176 (the strength of the magnetic field is itself a function, for example of the remnance magnetization of the magnetic particles 176, their size, the orientation of the magnetic particles 176 and the direction of magnetism), the sensitivity of the reading element being used to read the magnetic fields and the expected resolution of the overall system. Herein it is understood that the magnetic particles 176 may be distributed within a non-magnetic (or weakly magnetic) matrix material such as a polymeric material, metallic material, glass material or ceramic material said non-magnetic or weakly magnetic material providing one or more of: protection for the particles, cohesion between the particles and the other layers present (i.e. the non-magnetic material locks the magnetic particles in place—a form of adhesive, for example) and ease of application of the particles to the base or cover layer. In such cases the “magnetic particles 176” is understood to include the non-magnetic matrix material where applicable. In certain cases there may be no specific base layer 192 and the magnetic particles 176 may be directly in contact with an adhesive layer at the base of the tag, or they may be exposed.

The magnetic particles 176 may include a high coercivity material. An exemplary high coercivity material is a neodymium magnet comprising Nd, Fe and B. The magnetic particles 176 may include a ferrimagnetic material, an antiferromagnetic material, a ferromagnetic material or domains of varying magnetic properties within a continuous material (including voids causing variable magnetic properties) and combinations thereof. The ferromagnetic material is selected from the group consisting of MnBi, CrTe, EuO, CrO₂, MnAs, Fe, Ni, Co, Gd, Dy, corresponding alloys and oxides of Fe, Ni, Co, Sm, Gd, Dy, and combinations thereof.

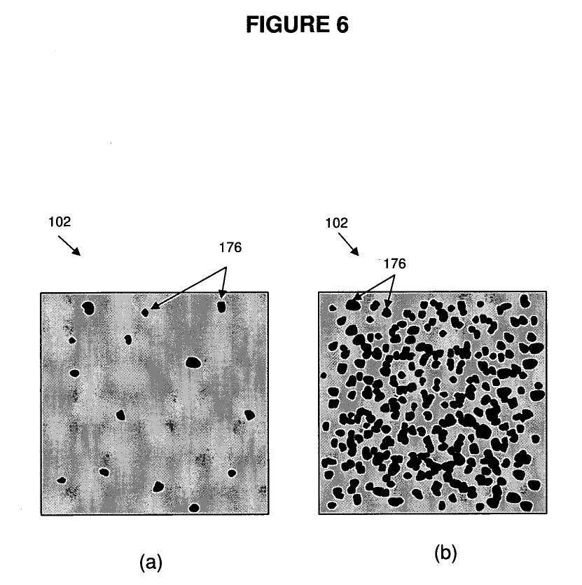

In order to be suitable, the area on a tag 102 to be read by a reading element may contain a suitable density of particles. FIG. 6A and FIG. 6B show different densities of magnetic particles contained within the areas of two tags 102 to be read in accordance with an embodiment of the invention. FIG. 6A shows a very low density of magnetic particles 176 while FIG. 6B shows a very high density of magnetic particles 176. If the area of the average tag 102 to be read contains too few magnetic particles 176, as may be the case with FIG. 6A, it may be difficult to achieve a large number of tags 102 with uniquely identifiable fingerprints. Similarly if the area of the average tag 102 to be read contains too many magnetic particles 176, as may be the case with FIG. 6B, it may also be difficult to achieve a large number of tags 102 with uniquely identifiable fingerprints. Consequently it is generally desirable to ensure that the tags 102 being used have a suitable density of magnetic particles 176, for example it is possible to set a threshold that all tags 102 used must have between 20 and 50 magnetic particles 176 of at least a certain size. Tags 102 which either have too many or too few magnetic particles 176 can be rejected on the production line, for example at the time of first reading and storing the signal.

Since most imaging chips (for example CMOS chips) are actually digital representations of the image (i.e. they are pixilated), in some cases it is simpler to base the acceptance criteria directly on the pixels of the image, as described hereafter. Assume for example that the magneto-optical reading element is configured such that a more intense magnetic field results in a brighter image and the imaging sensor records the brightness on a scale of 0 to 255 (with 255 being the brightest). Then another way of ensuring that there is a suitable magnetic fingerprint is to count the number of pixels which are registering a brightness value above a certain threshold value (for example above a threshold value of 128 on the scale of 0 to 255). If a sufficient number of pixels are above the threshold then it can be assumed that the tag 102 has sufficient number of magnetic particles 176 (or at least that those magnetic particles 176 which are present are particularly large, i.e. there is a sufficient portion of the area which is magnetized). On the other hand, in order to check that the tag 102 does not contain too many magnetic particles 176, it can be sufficient to check that not more than a maximum number of pixels are above the threshold (similarly this would actually check that the magnetized area is within the threshold). A further suitable quality control step is to ensure that a certain number pixels above a set threshold are surrounded by a certain number of pixels below a set threshold, thus ensuring that discrete regions exist being representative of spatially resolved features.

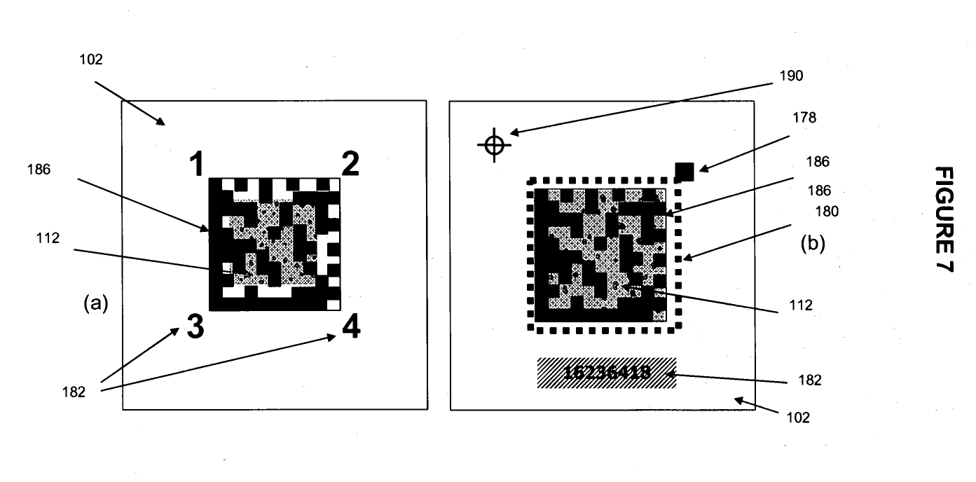

FIGS. 7A and 7B show further examples of tags 102 with identification features in accordance with an embodiment of the invention. As additional identification features provide additional security or information, multiple identification features may be adopted. Some of these additional identification features include magnetic barcodes, magnetic borders, magnetic alphanumeric characters, magnetic fiducial mark, optical barcodes (linear and 2-dimensional, including various industry standards such as DataMatrix), optical fiducial mark, optical alphanumeric characters, visible markings but not so limited, for example the tag 102 may include a Radio Frequency Identification (RFID) chip, security inks or a hologram. The first barcode 184 or the second barcode 186 may be printed using covert inks such as ultraviolet or infrared “optical” inks that cannot be detected by the naked human eye but can be detected and read by using a suitably adapted reading device 104 or by illuminating the tag 102 with one or more particular wavelengths of the electromagnetic spectrum. Magnetic and optical identification features may be positioned at the same position with respect to the scan area by means of using multiple layers.

FIG. 7A shows a tag 102 with a magnetic fingerprint region 112. A second two-dimensional barcode 186 is partially overlapping the magnetic fingerprint region 112 and a plurality of magnetic alphanumeric characters 182 are positioned at the four corners of the second two-dimensional barcode 186. Note that although the magnetic fingerprint region 112 is shown in FIG. 7A and FIG. 7B, the fingerprint region 112 may preferentially be situated behind an opaque cover layer that the second barcode 186 is printed on. Therefore, a user may not actually see the fingerprint region 112. Furthermore, magnetic and optical features may overlap while placed on the same or different layers of a tag 102.

FIG. 7B shows a tag 102 with a magnetic fingerprint region 112. A second two-dimensional barcode 186 is overlapping the magnetic fingerprint region 112. The second two-dimensional barcode 186 is surrounded by a second fiducial marking 180 and a first fiducial marking 178 is positioned at the upper-right corner of the magnetic border 180. A third fiducial marking 190 is positioned on the upper-left corner, adjacent to the second fiducial marking 180. Magnetic alphanumeric characters 182 are positioned adjacent to the second fiducial marking 180.

The magnetic particles 176 used in forming the magnetic fingerprint region 112 are usually of high coercivity. One form of such high coercivity magnetic particles 176 is a flake-like geometry.

It may be advantageous for a reading element to read overlapping optical and magnetic features of the tag 102. Overlapping and similar terms are to be understood to mean located in the same area, superimposed, or on top of each other. Optical and magnetic feature of the tag 102 may overlap on the same or different layers of tag 102. One advantage found herein of reading overlapping optical and magnetic features is it allows for a smaller tag 102. It also provides more accurate correlation between the magnetic and optical features for matching because the optical features, used as a reference for fingerprint matching of the magnetic features, are physically closer to the magnetic features. Such a reading element and related devices, tags, and methods are described in detail below.

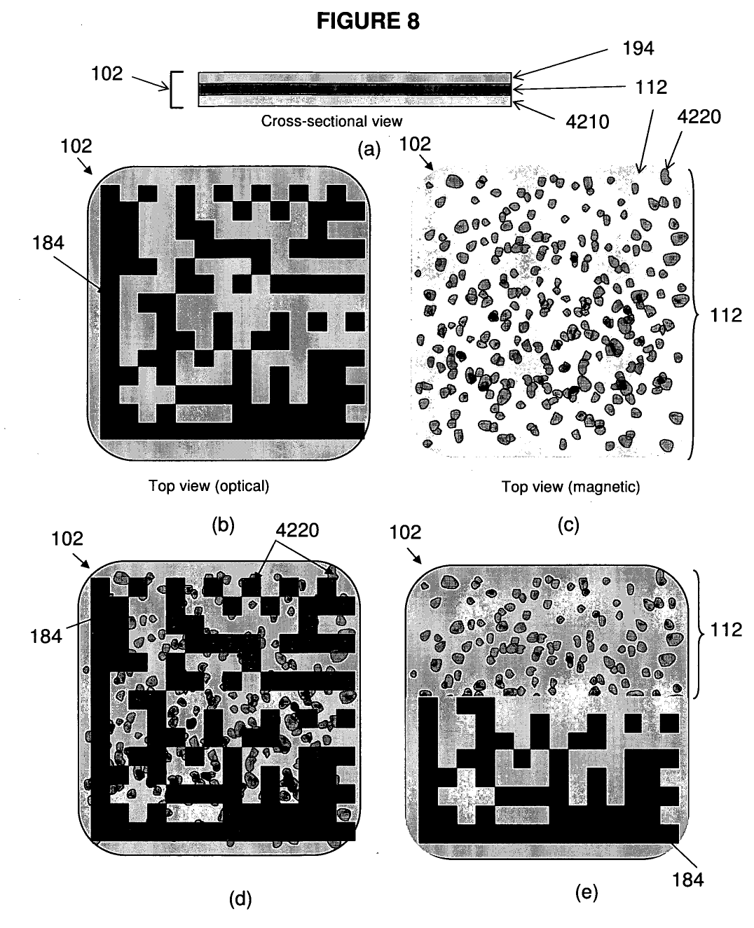

FIGS. 8A to 8E shows a cross-sectional view of a tag 102 where the magnetic information and the optical information overlap. In FIG. 8A, the tag 102 may include a cover layer 194 which has an optical barcode (not shown) (herein a “barcode” is taken to include datamatrix codes and other machine readable optical information) printed on its top surface, a magnetic fingerprint region 112 which may be in the form of a layer positioned below the cover layer 194 and an adhesive layer 4210 positioned below the magnetic fingerprint region 112. Note that a barcode is shown as the optical marking purely for illustrative purposes. The description that follows for this figure and other figures should be considered to be general and not confined to barcodes.

FIG. 8B shows a top optical view of the tag 102. Optical information in the form of a barcode 184 which has been printed on the surface of the tag 102 may be seen from the top view of the tag 102.

FIG. 8C shows a top magnetic view of the tag 102. If the user is able to take a magnetic image of the tag 102, the user can effectively look “through” the cover layer 194 and the optical information 184 and “see” the magnetic particles 4220 contained within the magnetic fingerprint region 112.

Although the magnetic particles 4220 are described as being of a certain “color”, the colors are described in the context of the black and white figures. Moreover, the “color” of the magnetic particles 4220 is a function of what light source 140 is being used, the properties of the magneto-optical substrate 138, and the optical set-up of the reading element. Furthermore the “color” or intensity of the light detected as a result of the magnetic particles 4220 is also dependent on the magnetic field in the region of the layers 156, 158 and 160 due to the magnetic particles 4220. For example, a north field may result in an intense (light) area while a south field may result in a dark (or less intense) region. The strength of the magnetic field (among other factors) will determine the intensity of the light. Therefore the intensity of the light will vary across a magnetic particle 4220 as the intensity of the magnetic field varies. Thus, the magnetic particles 4220 shown in FIG. 8C may vary in light intensity or color across each magnetic particle 4220 rather than being uniform.

FIG. 8D shows a top view of the composite image (i.e. the optical and magnetic features superimposed on each other). It is clear that when viewed from the top, the barcode 184 and the magnetic particles 4220 overlap each other.

When tag 102 is scanned by a reading element capable of reading only optical or magnetic features in a given area, FIG. 8E illustrates the resulting scan, wherein one half of the magnetic fingerprint region 112 is scanned and the other half of the optical barcode 184 is scanned. In the case where the optical barcode 184 is a datamatrix code as shown, scanning only half of the area may not necessarily be sufficient to fully interpret the number (or the entire datamatrix information). Therefore it may not be possible to fully interpret the optical information.

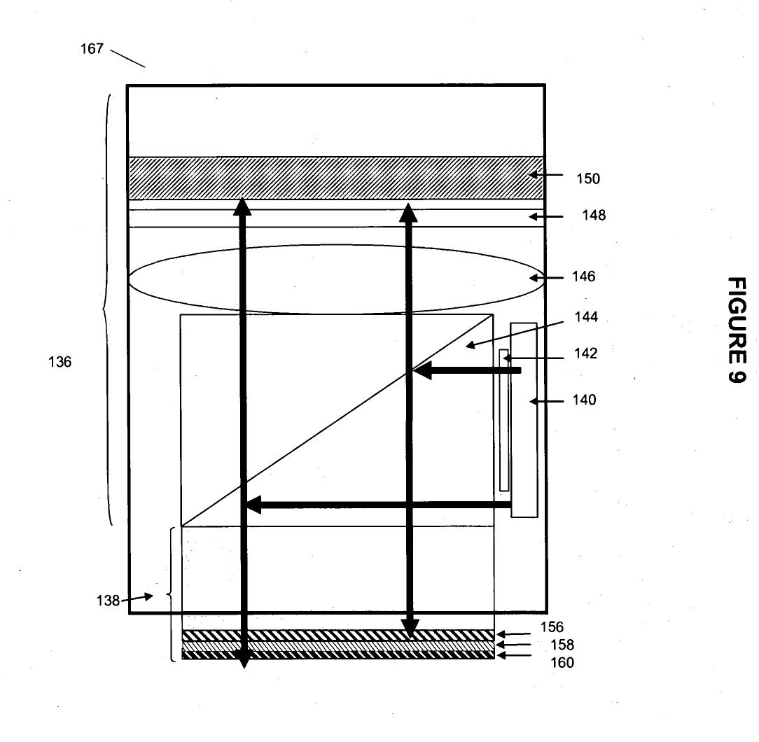

FIG. 9 shows a cross-sectional view of a reading element 167 in accordance with another embodiment of the invention. The reading element 167 is adapted to read both magnetic information and optical information at the same time. In one suitable configuration, the reading element 167 includes a single polarizer 142, 148, a common lens system 146, a beam splitter 144 and a single light source 140.

In one embodiment, at least some light passes through the first coating layer 156, the second coating layer 158 and the protective layer 160. Assuming that the surface of the tag 102 is sufficiently reflective, light will also be reflected from at least some portions of the surface of the tag 102 and pass back through the reading element 167 to be captured by the optical detector 150. That is, at least a portion of light is reflected from the surface of the tag 102 and not internally reflected within reading element 167. Assuming that at least portions of the tag 102 shown in FIG. 8A are sufficiently reflective (clearly the black areas of the optical barcode 184 will not reflect as much as the other areas), the optical detector 150 will detect a combination of the light as altered by the magnetic features and optical features. In one embodiment, magneto-optical substrate 138 may span substantially the entire width of reading element 167. In one embodiment, magneto-optical substrate 138 may span substantially the entire scan area of tag 102. In one embodiment, reading element 167 may comprise coils (not shown) or other structures to conduct an electric signal, wherein the electric signal would cause the magnetic particles 4220 of tag 102 to generate a magnetic field (in such a case the preferred magnetic materials are soft low coercivity magnetic materials such as iron-based ferromagnetic materials). In one embodiment, reading element 167 may comprise magnets (not shown), wherein the magnets may form a substantially uniform magnet field with respect to a scan area of tag 102.

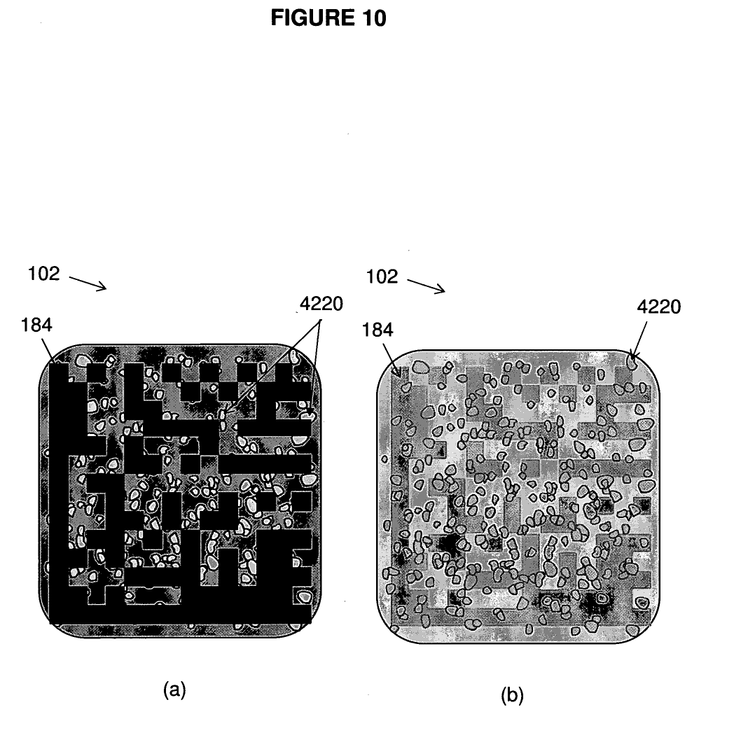

FIG. 10A shows a scan area of tag 102 with optical barcode 184 and magnetic particles 4220 (from FIG. 8A) where the reading element 167 in FIG. 9 involving a grayscale optical detector 150 is used. In some embodiments, a monochromatic light source is used. As can be seen in FIG. 10A, the result is a combination of the optical barcode 184 and magnetic particles 4220. In the example shown in FIG. 10A, all optically black regions do not reflect sufficient light and so are seen as being black whether or not a magnetic particle 4220 is present at that location. However where the tag 102 is at least somewhat reflective (i.e. the areas between the black markings) the reflected light appears more intense (i.e. whiter) in the regions where a magnetic particle 4220 is present. This occurs because the reflective areas reflect the same amount of light no matter whether a magnetic particle 4220 is present at that position or not. However if a magnetic particle 4220 is present, the polarization of the light is slightly altered and, depending on the optical setup, more such altered light may pass through the polarizer 148 and will therefore appear as a bright spot to the optical detector 150. Note that this system/configuration may work best when the reflective areas of the tag are shiny or minor-like since if they are matt or otherwise scattering they can alter the polarization of the light hitting them which may reduce the ability of the reading element to detect the magnetic features. There are many variations of this that can be employed, e.g. using monochromatic light sources of various colors and various color schemes of printed information on the surface of the tag 102 itself. Note here and in other examples that depending on the optical configuration chosen and the polarization of the magnetic particle 4220, it may be easy to make the magnetic particles 4220 appear as bright or dark areas, or (if a combination of polarizations are used) as varying bright and dark regions. By using this configuration it may be easier to compare the positions of the magnetic features within the reflective area of the tag with those used to create the reference signature. In this case the matching is only concerned with magnetic information corresponding to the reflective areas of the tag and the magnetic information within the dark (black) areas is ignored. Consequently, the datamatrix may be more difficult to interpret due to the presence of the magnetic information since the reflective areas will vary in brightness in the image, but this generally easy to overcome by methods such as just setting a threshold of brightness and assuming that all pixels brighter than that threshold are considered to be part of their reflective area irrespective of how bright they actually are.

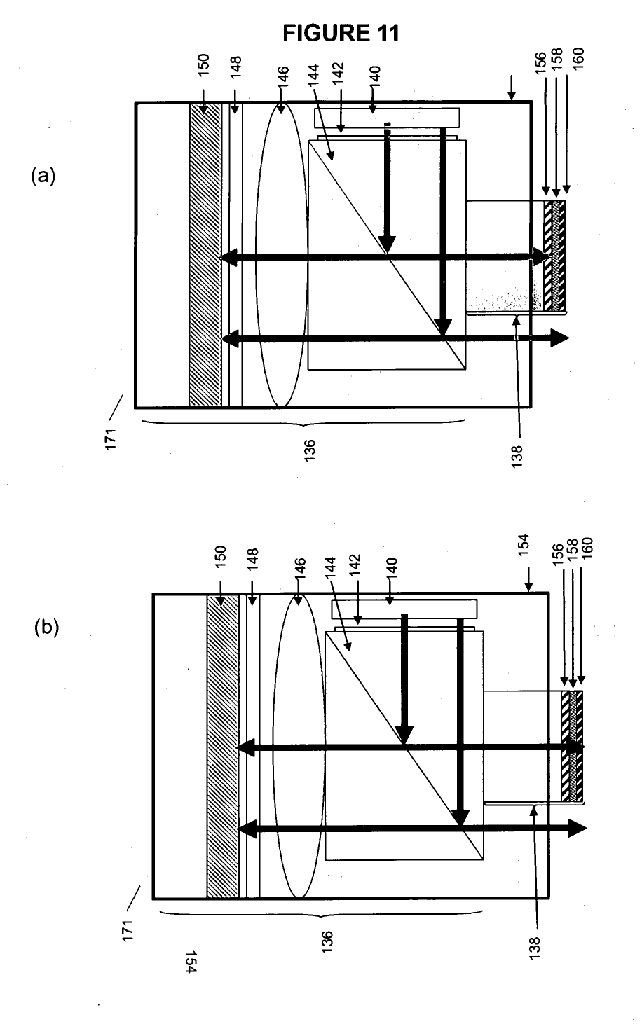

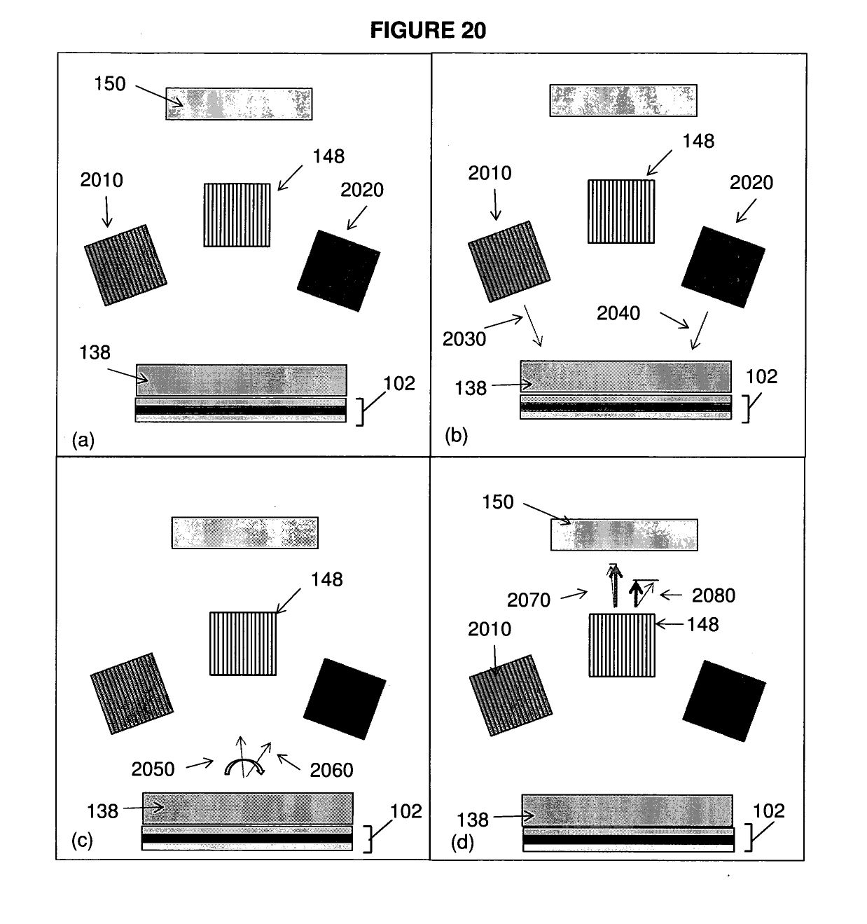

FIG. 10B shows a scan area of a tag 102 where the reading element 167 in FIG. 9 is used in conjunction with a tag 102 which has a blue green barcode printed on a reflective surface. Here the light source 140 is assumed to be a white light source. A white light source is used in conjunction with a magneto-optical substrate 138 that is assumed to respond best in the green-light domain. Thus, when white light is used, a magnetic region appears as green to the optical detector 150 because of the properties of the magneto-optical substrate. Although the scan area of tag 102 appears as various shades of green to reading element 167, the shades of green will be represented by black and white figures. Thus, it is seen that the magnetic particles 4220 appear to be bright spots and the optical barcode 184 appears darker. Where there is a magnetic particle 4220 at the same place as a portion of the optical barcode 184, the green of the optical barcode 184 and of the magnetic particles 4220 will interact to form another variation of green, but for the sake of better describing embodiments of the invention, the variations are not shown. Although the reading element 167 in FIG. 9 is used as the example in the descriptions (above and below) the concepts are not limited to the reading element 167 of FIG. 9 and shall be considered as general concepts applying to all reading elements (particularly those shown in FIGS. 11, 18, 19, and 20). In this case it may be advantageous to use a different wavelength of light for interpreting the barcode, e.g. if the mageto-optical substrate works preferentially in the green domain, then that domain can be used to read the magnetic information, while the red domain, for example, could be used to interpret the optical information (the blue green barcode would appear black in the red domain while the other parts of the reflective surface would appear bright in the image). If wished this kind of system may be improved further by using two different light sources in the reading element—the green light source is polarized for example while the red light source is left unpolarized for example (FIG. 20 provides a reading element configuration suitable for this). This configuration allows the red domain of the image to be a pure optical image free from any magnetic information at all. Herein words such as “pure” and “free” and other absolute terms are not considered in their absolute form but as an indicative form (i.e. “substantially free”). For example although we say a “pure optical image free from any magnetic information at all”, in reality CMOS imaging devices (for example) have some cross-talk between the red, green and blue sensors such that these the “red domain” from the imaging device does include some input from the green and blue domains—this is a well known phenomenon and there are various methods to try to minimize this by subtracting some portion of the green and blue images from the red to render a purer red image. So when saying a pure image it is understood that absolute purity is something which is often not practically achievable, however it is intended in the context of being “pure” for the purposes of use within the context of the invention.

In another embodiment, a partially reflective second coating layer 158 is used. FIG. 9 is also used as an example of a reading element 167 in this embodiment. By tuning the amount of light that is reflected by the second coating layer 158 and the amount of light that is allowed to pass through the second coating layer 158, the relative contribution of the magnetic particles 4220 and optical features 184 on the final image captured by the optical detector 150 may be optimized. For example, in FIG. 8A, a partially reflective second coating layer 158 may be configured so that enough light reflects above the areas of the black markings of a barcode and therefore enables the detection of the presence of the magnetic particles or features 4220 overlapping a barcode. Here a “partially reflective second coating layer 158” is understood to include a reflective polarizing film which has been oriented such that the light which has had its polarization altered by the magneto-optical substrate 138, particularly the first coating layer 156 and the second coating layer 158, is preferentially reflected. This means that the magnetic information will be enhanced compared with other non-selective but partially reflective mirrors.

In another embodiment, a wavelength selective second coating layer 158 is used. A further method to achieve a simultaneous scanning of the optical features 184 and the magnetic particles 4220 from the same area is to use a wavelength selective second coating layer 158 or filter system. Dichroic mirrors and dielectric mirrors, for example, are thin film mirrors that reflect a selected wavelength of light (or range of wavelengths) while allowing the other wavelengths to be transmitted through the mirror. Note that the respective reading element 171 or optical setup shown in FIG. 11A and FIG. 11B are again purely for illustrative purposes and the exact configuration will depend on the optical and mirror properties desired. In both FIG. 11A and FIG. 11B, the second coating layer 158 is assumed to be a wavelength selective mirror which reflects green light but allows red light to be transmitted (FIG. 11A shows red light being transmitted through the second coating layer 158 and through the protective layer 160 (although the tag is not shown, the light is being reflected off the surface of the tag), and FIG. 11B shows green light being reflected by the selective second coating layer 158). Note that, as in all examples, although the second coating layer 158 (or other layers) are described as being a single layer, this is for illustrative purposes and it is assumed that this includes situations where the “layer” is in fact a plurality of layers, e.g. in the case of such wavelength selective mirrors, each wavelength selective mirror generally includes a series of layers. FIG. 11A and FIG. 11B also assume that the magneto-optical substrate 138 is smaller than the optical viewing area of the optical processing unit 136—this is not necessarily always desirable and the magneto-optical substrate may alternatively stretch across the entire front portion of the reading element. The other components within the reading element 171 are the same as in FIG. 9.

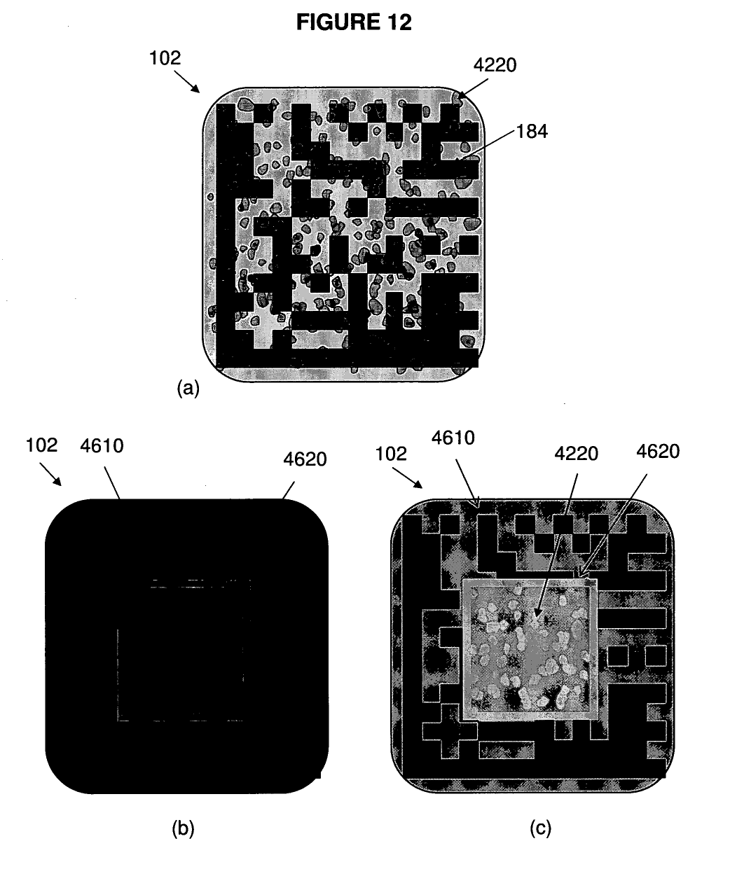

FIG. 12A shows a top view of a tag 102 with its optical 184 and magnetic features 4220 artificially superposed. FIG. 12B shows a red-spectrum image of the tag 102 taken using a reading element 171 as described in FIG. 11A and FIG. 11B. FIG. 12C shows a green-spectrum image of the tag taken using a reading element 171 as described in FIG. 11A and FIG. 11B. In both FIG. 12B and FIG. 12C, the area of the image outside of the magneto-optical substrate 138 is marked as 4610 while the area of the image where the magneto-optical substrate 138 is present is marked as 4620. Note that if the optical detector 150 is, for example a CMOS image sensor then it is possible (for most commercial CMOS imaging chips) to acquire both the red- and the green-spectrum images simultaneously. This is because in most commercial CMOS sensors, the imaging photocells are grouped into clusters of four photocells each sensing one color, generally they follow a format of one red-sensing photocell, two green-sensing photocells and one blue-sensing photocell. This is commonly known as the “RGGB” configuration which stands for Red, Green, Green, Blue. If the user wants a full color image, the signals from all photocells can be combined to recreate the full color spectrum, however it is just as easy to separate the spectra from each other and deal with the red, green and blue spectra separately.

As shown in FIG. 12B, the area of the red-spectrum image (represented in black and white) where the magneto-optical substrate 138 is present is not purely an optical image, it also contains some brighter areas where the magnetic particles 4220 are present. This is because even though the majority of the red spectrum light passes through the second coating layer 158 and is reflected by the surface of the tag 102 (i.e. an image of the optical markings on the surface of the tag 102) the light nevertheless passes through the first coating layer(s) 156 (both on the way towards the tag 102 and after it has been reflected from the surface of the tag 102) and the polarization of the light is altered as it passes through the second coating layer 158 due the presence of a magnetic field. This means that where the magneto-optical substrate 138 is present the red-spectrum image is actually a combination of the magnetic 4220 and optical 184 features. However, if necessary, the magnetic features 4220 can be removed using the information from the green-spectrum image (represented in black and white) as shown in FIG. 12C because the green-spectrum image provides us with an image of the magnetic features 4220 without the optical features (in the area of the magneto-optical substrate 138). Using this method, one “snap-shot” from the optical detector 150 is able to provide us both the magnetic 4220 and optical 184 features from the tag 102 and importantly the spatial position of the magnetic 4220 and optical 184 features with respect to each other is very accurately measured.

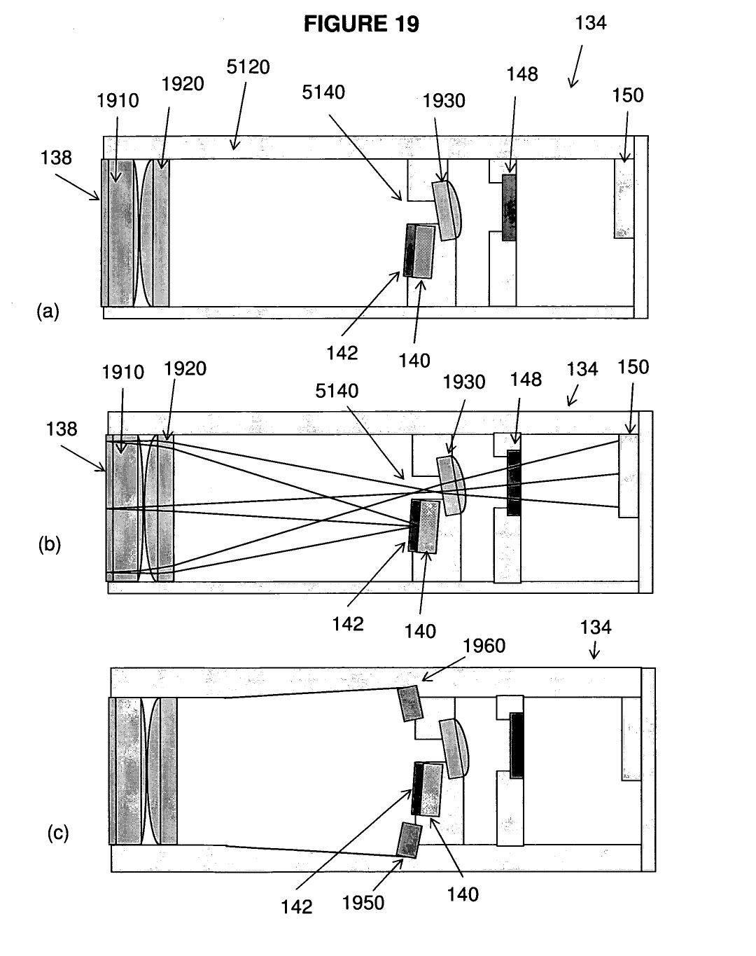

In another embodiment, a polarizer 142 is used to tune how predominantly magnetic 4220 and optical 184 features are present in a spectrum image (e.g., FIG. 12B and FIG. 12C). That is, the polarizer 142 may be configured so that magnetic 4220 and optical 184 features are enhanced and/or suppressed in a spectrum image. A further method to achieve a simultaneous scanning of the optical features 184 and the magnetic particles 4220 from the same area is to polarize a selected wavelength of light (or range of wavelengths) while not polarizing other wavelengths. The reading element shown in FIG. 19C, for example, can read magneto-optical information in the manner described above. This is a highly effective means of simultaneously reading magnetic and optical information since if the red spectrum of the light were not polarized then the magnetic features would not influence the red image at all and the faint magnetic features shown in FIG. 12B would not be present, i.e. the optical image inside the magneto-optical area, 4620, is “clean”. This is also discussed in relation to FIG. 19C. After the polarized and un-polarized light is reflected off the magneto-optical substrate 138 and/or tag 102, the two resulting images, for example FIGS. 12B and 12C, may be used separately or combined so that only the optical 184 or magnetic 4220 features are shown.

In one embodiment, a switchable mirror is used. FIG. 9 is also used as an example of a reading element 167 in this embodiment. The second coating layer 158 is made into a switchable mirror, i.e. a film which is able to change its optical reflectivity or transmission properties based on an input such as an electrical field. One example of a switchable mirror is described in “Proton Conductive Tantalum Oxide Thin Film Deposited by Reactive DC Magnetron Sputtering for All-Solid-State Switchable Mirror”, K Tajima, Y Yamada, S Bao, M Okada and K Yoshimura, Journal of Physics: Conference Series 100 (2008) 082017 (doi:10.1088/1742-6596/100/8/082017)”, however there are many examples of different technologies being used as switchable mirrors, for example U.S. Pat. No. 6,647,166 and U.S. Pat. No. 7,042,615 and US Patent Application 2008/0186560. By using a switchable mirror the magnetic and optical information can be scanned (e.g. a picture taken) at slightly different times but of exactly the same area. By switching the mirror quickly between taking subsequent images, it is possible to take full area images of both optical and magnetic information without additional complexity. By switching several times, it is also possible to ensure that the original optical reference(s) is still in the same position at the end of the image acquisition sequence, and hence that the device has not been inadvertently moved during the process.

Thus, the second coating layer may be configured to change a reflective property. A reflective property includes, but is not limited to, a polarization property and a wavelength property. That is, the second coating layer may alter which light it reflects or passes though based on polarization or wavelength of light. Examples of layers capable of achieving this are known in the art, such as “Switchable optical polarizer based on electrochromism in stretch-aligned polyaniline”, Appl. Phys. Lett. 83, 1307 (2003).

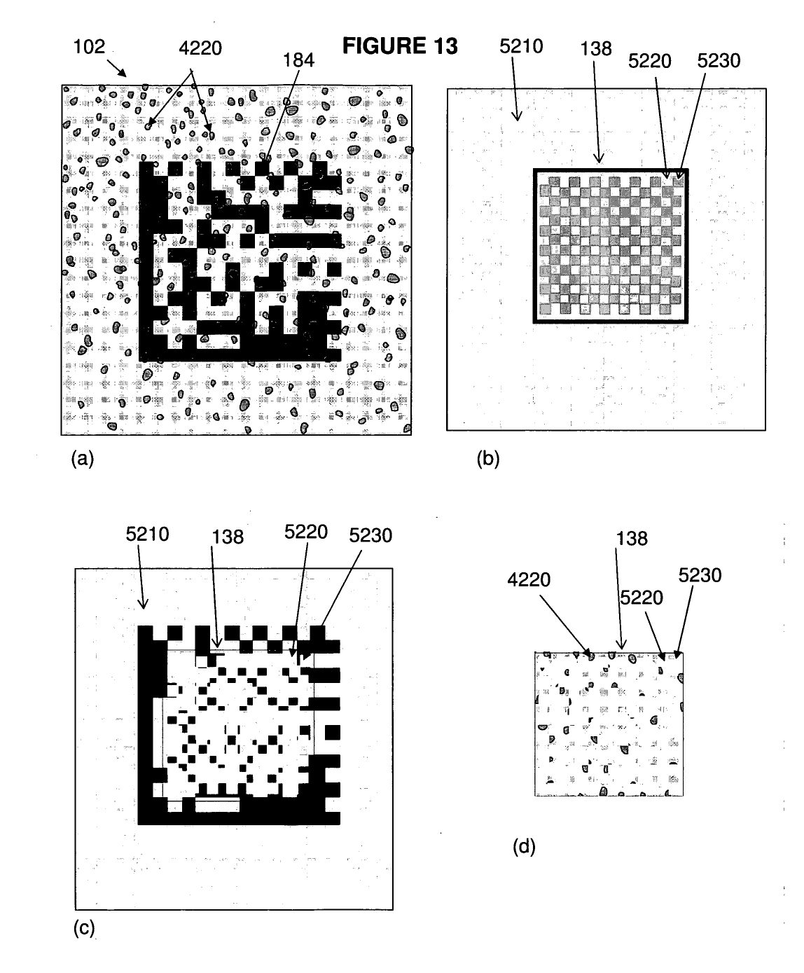

In one embodiment, a patterned mirror as the first coating layer 156 and/or the second coating layer 158 may be used. The second coating layer 158 (and if necessary the first coating layer 156) is patterned such that some regions of the surface of the magneto-optical substrate 138 are reflective and some are transparent. FIG. 13A shows a top view of a tag 102 is shown with its optical 184 and magnetic 4220 features artificially superposed. The tag 102 is to be read with a reading element that has a magneto-optical substrate 138 with the first coating layer 156 and/or the second coating layer being a patterned mirror layer(s) on its surface.

FIG. 13B shows a configuration of an imaging area of the tag taken using the reading element. The majority of the image is a purely optical image area 5210. The magneto-optical substrate 138 is partitioned into small square regions some of which are dedicated to optical imaging 5220 and the others 5230 are dedicated to imaging the magnetic features. The magnetic 4220 and optical 184 imaging squares are arranged in an array across the area of the magneto-optical substrate 138. FIG. 13C shows just optical tag information from an image taken of the tag using the reading element shown in FIG. 13A. The outline of the magneto-optical substrate 138 is shown as a thin line so that the viewer can easily see the position of the magneto-optical substrate 138 with respect to the rest of the image. Here optical information is obtained from the entire region 5210 and also from the optical portion 5220 of the magneto-optical substrate 138. In FIG. 13C, the magnetic portions 5230 of the magneto-optical substrate shown as pure white regions. The same image captured by the CMOS sensor also contains the magnetic features 4220 that correspond to the magnetic imaging squares 5230 of the magneto-optical substrate 138. The portion of the image is shown in FIG. 13D. The optical portion of the image is just left as pure white and only the portion of the image pertaining to the magnetic information is shown. The outline of the magneto-optical substrate 138 is shown as a thin line so that the viewer can easily see the position of the magneto-optical substrate 138 with respect to the rest of the image.

Note that the actual image taken by the CMOS imaging chip is actually the sum of the two images shown in FIG. 13C and FIG. 13D. However the portions of the images are split to emphasize that the data obtained from the portions of the image can be treated separately. This is easy to do since the relative position of the magneto-optical substrate 138 with respect to the CMOS imaging chip is fixed. So it is simple to calibrate which portions of the image relate to magnetic features 4220 in the tag 102 and which relate to the tag 102's optical information 184. Note that by choosing the magnetic 5230 or optical 5220 regions of the magneto-optical substrate 138 correctly it is possible to decipher the tag 102's datamatrix code even though portions of it are not visible due to the magnetic imaging regions.

In FIG. 13B and FIG. 13C, the optical and magnetic portions of the magneto-optical substrate 138 have been chosen to be about a quarter of the area of the datamatrix elements. This means that a portion of each datamatrix element is sampled and that is sufficient to tell whether that particular datamatrix element is black or white (unless there is substantial damage to the datamatrix element). This configuration provides a simple way to achieve simultaneous reading of the magnetic 4220 and optical 184 features of the tag 102 and provides ample information to decipher the datamatrix code and accurately map the position of at least some of the magnetic features 4220 with respect to the optical markings 184 on the tag 102. This method may provide less area for sampling the magnetic features 4220 and therefore care needs to be taken when designing the system that the tags 102 contain sufficiently dense packing of magnetic features 4220 such that the user will have a very good possibility of sampling sufficient magnetic features 4220 to allow accurate and reliable matching to occur. Similarly the optical information 184 is, in parts, blocked by the magnetic imaging regions 5230 and therefore care must be taken in choosing the tag 102's optical features 184 such that they can be easily deciphered and the image has a good possibility of having sufficient optical feature 184 sampling to ensure accurate mapping of the magnetic features 4220 with respect to the tag 102's optical markings.

Note that in this method the first coating layer 156 of the magneto-optical substrate 138 and/or the second coating layer 158 of the magneto-optical substrate 138 and/or protective layer 160 may be patterned to allow optimal optical imaging to occur in the optical imaging regions. These regions shall not be so small that diffraction causes reading problems. Patterning of these regions can be accomplished by a variety of standard lithographic techniques such as using a photolithographic patterning technique (for example) in conjunction with one or more of lift-off patterning, wet-chemical etching, or dry etching (e.g. reactive ion etching), for example. Various combinations of the above-mentioned inventions may be employed, e.g. a patterned switchable mirror. Note for all the configurations where one is seeing optical features 184 from the tag 102 through the first coating layer 156, the protective layer 160 must be at least partially transparent.

There are many ways to use the reading elements described above to normalize the magnetic information on a tag 102 based on the optical information on the tag. By this we mean that the optical information printed on the tag 102 can be used to accurately position the magnetic features with respect to some reference reading of the tag 102. One method may be described below using a datamatrix marking as the optical reference.

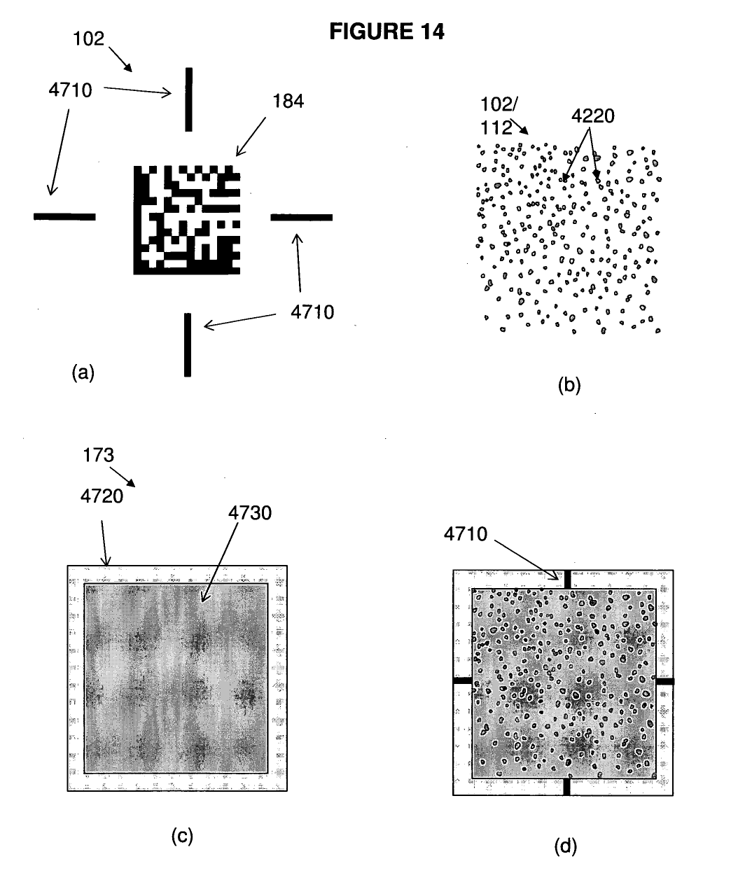

FIG. 14A shows an optical top view of a tag 102 that is being produced. There is a datamatrix 184 printed on the surface of the tag 102 and around the datamatrix 184 there are four optical fiducial markings 4710 radiating outwards. FIG. 14B shows a magnetic top view of the same tag 102 that is being produced. Below the surface of the tag 102 there is a magnetic fingerprint region 112 including magnetic features 4220.

FIG. 14C shows a configuration of a reading element 173 which may be used to read the datamatrix 184 and the magnetic features 4220 on the tag 102. On the production line, there is at least one reading element 173 and this reading element 173 can be used to obtain the reference reading of the tag 102 allowing the reference signature of the tag 102 to be stored in a database. This reading element 173 has a larger scanning area than the reading elements used to read the tags in the field, and furthermore it may be configured differently. The majority of the scan area is dedicated to scanning magnetic data (scan area 4730) while just a peripheral area 4720 is dedicated scanning optical information.

When this reading element 173 is placed on top of the tag 102 that is being produced, an image such as that shown in FIG. 14D is obtained. This image may be used to derive the reference signature of the tag 102 that is stored in a database. Here a portion of the fiducial markings 4710 are visible through the peripheral optical viewing area, while the majority of the image shows the magnetic features 4220 of the tag 102. Assuming that the fiducial markings 4710 and the datamatrix 184 are printed in the same printing step and are therefore aligned accurately with respect to each other (i.e. that one can reliably deduce the position and of the optical features that comprise the datamatrix 184), the image shown in FIG. 14D can be used to accurately map the position of each magnetic feature 4220 with respect to the position of the optical datamatrix features 184. If the relative position of the fiducial markings 4710 and datamatrix features 184 are not accurate or reliable with respect to each other, a high resolution optical camera can be used to measure the relative distances and this can be used to map the position and orientation of each magnetic feature 4220 with respect to the datamatrix features 184.

Note that the method of obtaining the reference image described in relation to FIGS. 14A to 14D above is just one method of achieving this. Other methods include stitching separate images together—generally these separate images may overlap at least in some regions, but this is not strictly necessary. Yet another method is to use a dichroic mirror on the magneto-optical substrate, this would allow simultaneous reading of the magnetic and optical information even within the area covered by the magneto-optical substrate.

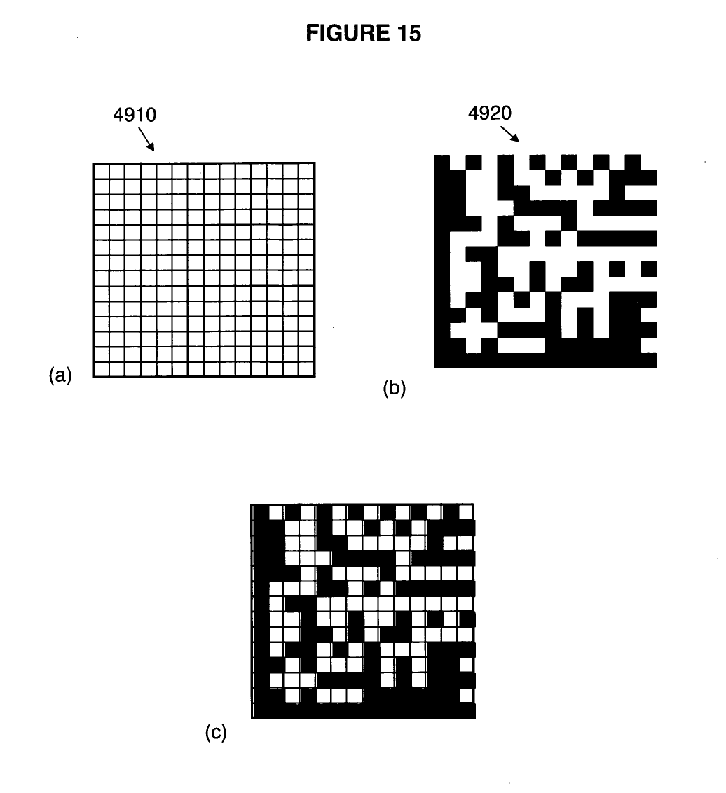

FIGS. 15A to 15C illustrates that a datamatrix code is actually well-suited to act as a reference optical marking for mapping the position of the magnetic features because it is based on a regular grid format. FIG. 15A shows a 14×14 element grid pattern 4910. FIG. 15B shows a standard 14×14 element ECC 200 datamatrix code 4920. In this case the code 4920 represents the 16 digit number “1234567890123456”. FIG. 15C shows a superposition of the grid pattern 4910 from FIG. 15A and the datamatrix code 4920 shown in FIG. 15B. It can be easily seen from FIG. 15C that the datamatrix code 4920 is simply a grid pattern where certain of the elements have been filled in black and others are left white. This means that such a datamatrix code 4920 can be used as a grid pattern for mapping the magnetic features. This example is chosen as it is very simple to understand however, it will be clear to anyone skilled in the art that a wide variety of optical markings can serve as reference markings with which to map the magnetic features. Both interpolation (usually for magnetic features within the optical marking region) and extrapolation (usually for features outside of that region) can be used.

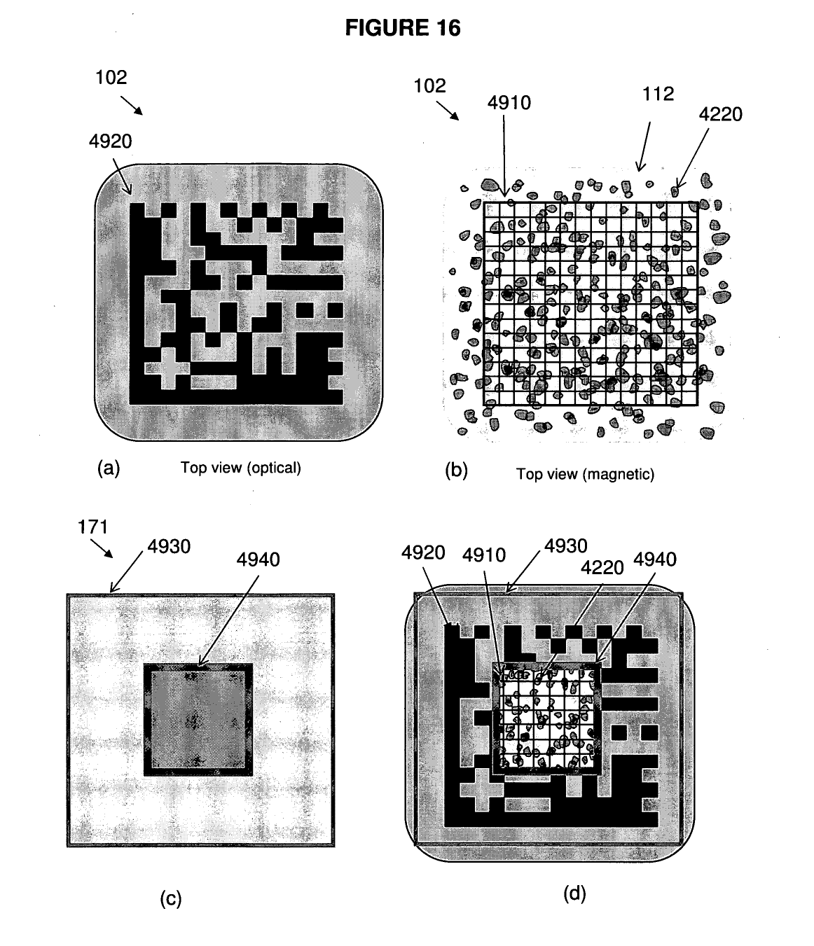

FIG. 16A shows an optical top view of a tag 102 such as the one that was shown during its manufacture in FIGS. 14A to 14D. Here the tag 102 has been die-cut such that the fiducial markings 4710 that were shown in FIG. 14A are no longer present and the only optical marking remaining on the surface of the tag 102 is the datamatrix code 4920. Let us assume for the discussion here that the reference reading of the tag 102 as described in relation to FIGS. 14A to 14D has occurred such that all the magnetic features 4220 within the final tag 102 (shown in FIG. 16B) have been scanned during the reference reading.

FIG. 16B shows the magnetic top view of the same tag 102. The magnetic fingerprint region 112 is shown to cover pretty much the entire area of the tag 102. There are numerous magnetic particles 4220 within the magnetic fingerprint region 112 and one such magnetic particle 4220 is marked. FIG. 16B also shows artificially how the grid pattern 4910 from the datamatrix code 4920 superposes on the magnetic particles 4220 allowing their position to be accurately mapped with respect to the optical datamatrix code 4920.

FIG. 16C shows a configuration of a reading element 171 to be used in the field. Here the optical scan area 4930 is substantially bigger than the magnetic scan area 4940. The outer perimeter of the optical scan area 4930 and the outer perimeter of the magnetic scan area 4940 are marked. Having a smaller magnetic scan area 4940 than the optical scan area 4930 can be achieved using a reading element 171 with the format shown in FIGS. 11A and 11B, for example.

FIG. 16D shows an image of the tag 102 when the reading element 171 is positioned centrally on the tag 102 shown in FIGS. 16A and 16B. The reading element 171 is able to scan both magnetic particles 4220 and datamatrix code 4920 from the tag 102 simultaneously. Again, the outer perimeter of the optical scan area 4930 and the outer perimeter of the magnetic scan area 4940 are marked. As in FIG. 16B, the grid pattern 4910 from the datamatrix code 4920 is artificially superposed on the magnetic features 4220 within the magnetic scan area 4940. By superposing the grid pattern 4910 artificially, one can demonstrate graphically how the position of the magnetic features 4220 imaged in this reading of the tag 102 can be correlated with the position of the magnetic features 4220 from the reference reading of the tag 102, i.e. how the signature derived from this reading can be compared with the reference signature (the reference reading was described in relation to FIGS. 14A to 14D) that has been stored in a database.

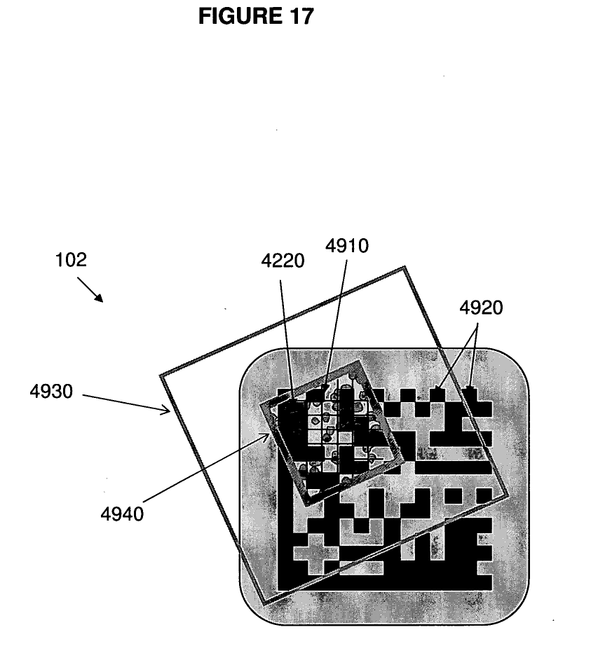

A further reading of the tag 102 is shown in FIG. 17. Here the reading element is poorly aligned with respect to the tag 102. The reading element is not centered and it is rotated with respect to the tag 102. Again, the outer perimeter of the optical scan area 4930 and the outer perimeter of the magnetic scan area 4940 are marked. As in FIG. 16D, the grid pattern 4910 from the datamatrix code 4920 is artificially superposed on the magnetic features 4220 within the magnetic scan area. By superposing the grid pattern 4910 artificially, one can demonstrate graphically how the position of the magnetic features 4220 imaged in this reading of the tag 102 can be correlated with the position of the magnetic features 4220 from the reference reading of the tag 102, i.e. how the signature derived from this reading can be compared with the reference signature (the reference reading was described in relation to FIGS. 14A to 14D) that has been stored in a database. This shows that even for very poorly aligned readings, the system is able to accurately map the position of the magnetic features 4220 that are being read to the reference reading. Note further that the magnetic features 4220 being scanned in this reading are different from the ones being scanned in the reading shown in FIG. 16D, but in both cases the magnetic features 4220 being scanned were scanned in the reference reading (described in relation to FIGS. 14A to 14D) where a much larger magnetic scan area was employed.

Therefore the reading in the field can be sufficient for matching provided that enough optical information is scanned such that the position of the magnetic features 4220 in the scan can be accurately mapped, and sufficient amounts of the magnetic features 4220 being scanned in the reading may also be scanned in the reference reading of the tag 102 such that a sufficiently accurate matching can be achieved. In the previous sentence “sufficient amounts” and “sufficiently accurate” are subjective terms and are used only to indicate that threshold levels may be set, e.g. “sufficient amounts” may be determined by cumulative magnetic strengths or number of magnetic particles 4220 present in the scan area and “sufficiently accurate” can be a threshold of statistical confidence in the matching result.

Regarding the mapping of the magnetic features 4220 from the reading in the field versus the reference reading, it should be noted that the optical features 4920 can be used as a first step to map the position of the magnetic features 4220 in both readings and a second mapping step may be needed for very accurate mapping. An example of this two step mapping is explained here: after the positioning or normalization is done using the optical information 4920, then a second step can be done where the magnetic features 4220 are used to achieve a more accurate positioning with respect to the stored reference signature obtained from a reference reading of the identification tag 102. This can be done by doing a correlation of the match obtained from the optical positioning step, thereafter the obtained image of the magnetic features 4220 can be stepped left, right, up and down within a certain tolerance range and after each step the data can be correlated again to obtain the best match. This will allow accurate positioning of the magnetic features 4220 with respect to the reference signature; however a limit to the amount of movement in each direction must be set in order to prevent the data to be moved to such an extent that it loses correlation with the optical markings 4920 and may cause incorrect false positive matching.

The example shown here where a smaller magneto-optical scan area is used for the readings in the field compared to the reference reading is by way of example only. Virtually any required sizes and configurations can be used provided that there is enough overlap in the magnetic features being read in the reference reading and the subsequent readings such that a sufficient matching is possible.

FIGS. 18A to 18C show a cross-sectional view of a reading element 134. In FIG. 18A, the reading element 134 may include a plurality of components or optical elements, for example a magneto-optical substrate 138, a light source 140, a first polarizer 142 and a second polarizer 148, a beam splitter 144 and an optical detector 150 can be seen. The lens system 146 which, in FIG. 9 for example are shown as just one element are now shown as a plurality of convex or concave lens elements 5111, 5112, 5113, 5114 and 5115. The components are housed within a protective tube 5120. Two lens elements 5113 and 5114 together with a pinhole 5140 are arranged within a housing 5130 which is movable with respect to the other components (which are all fixed with respect to the protective tube 5120). This moveable housing 5130 allows the focus to be adjusted such that any imperfections due to assembly or components do not cause the image to be poorly focused. This means that during the final assembly steps, the focus can be adjusted and the housing 5130 (and its associated components) can be set to the optimal position such that the image focus is sharp.

As in a standard optical arrangement, the pinhole 5140 allows the depth of field to be controlled, i.e. a small pinhole 5140 will result in a larger depth of field than a big pinhole 5140. However a small pinhole will cut off more light and therefore the image may not be as bright, or brighter light sources need to be used. Having a larger depth of field can be important in designs where both optical and magnetic information is being imaged at the same time (for example the configuration shown in FIG. 11A and FIG. 11B). An optical absorber 5150 is shown. This is to absorb stray light that may pass through the beamsplitter 144. The optical absorber 5150 may be made from any optically absorbing material, for example black felt. The inner walls of the protective tube 5120 and housing 5130 may be made to be black to absorb stray light.

FIG. 18B shows a light path 5170 travelling from the center of the light source 140 travelling to the center of the beam splitter 144. At least a portion of the light is reflected towards the magneto-optical substrate 138 (light path 5171), thereafter at least a portion of that light is reflected back towards the beam splitter and at least a portion of the light that reaches the beam splitter 144 passes through the beam splitter 144 and travels to the optical detector 150 (light path 5172).

Light may not only travel in the central path shown in FIG. 18B. FIG. 18C shows how light being reflected from different areas of the magneto-optical substrate 138 may travel through the reading element 134 and be collected at the optical detector 150. The basic optical imaging concepts and design of the optical elements to obtain a sharp image are well-known in the literature.

This is merely one practical design for the reading element configuration and many other configurations (some which do not include two polarizers, and others which do not include a beam splitter) are feasible.

For example, FIGS. 19A-19C depict a cross-sectional view of a reading element 134 which does not include a beam splitter. Here the reading element 134 utilizes an off-axis design. That is, the incoming light source 140 is shifted slightly off the central axis of the tube. This particular embodiment may include two polarizers. Polarizer 142 is placed in front of the light source 140. Polarizer 148 is placed in front of the optical detector 150. This particular embodiment includes three lenses, lens 1910, lens 1920, and lens 1930. Pinhole 5140 and a protective tube 5120 are also included. Protective tube 5120 is adapted to house the various components of the reading element 134 and keep them fixed in their respective positions. A magneto-optical substrate 138 covers the entire front portion of the reading element 134; however, alternative embodiments include smaller and larger magneto-optical substrate 138 sizes. Further, alternative embodiments include the magneto-optical substrate 138 being placed in various positions and orientation with respect to the front of the reading element 134.

FIG. 19B shows light emanating from light source 140 being reflected from different areas of the magneto-optical substrate in accordance with an embodiment of the invention. The light radiates out from the light source 140. It passes through the first polarizer 142 and then through the front lenses 1920 and 1910 before reflecting off the mirror layer of the magneto-optical substrate 138. In some embodiments, magneto-optical substrate 138 may include a dichroic mirror layer. In some embodiments the magneto-optical substrate 138 does not include a mirror layer. In some embodiments, at least some light passes through magneto-optical substrate 138 and is reflected off a tag (not shown).

After the light is reflected off a mirror layer, tag, or a combination thereof, the light passes through the front lenses 1920 and 1910 again and through the pin hole 5140 to the final lens 1930. The light then passes through the second polarizer 148 and onto the optical detector 150. Thus, this embodiment is configured such that light reflected from the magneto-optical substrate 138 is focused onto the surface of the optical detector 150. The rotation of the second polarizer 148 with respect to the first polarizer 142 will influence the magnetic versus optical components of the image taken by optical detector 150.

FIG. 19C shows a cross-sectional view of a reading element in accordance with another embodiment of the invention. In some embodiments, the additional light sources 1950 and 1960 may or may not be fitted with polarizers. In some embodiments, the polarizers fitted onto the additional light sources may not be oriented the same way. Light sources 1950 and 1960 may be positioned in any suitable position within the reading element 134. This arrangement is suited for use with a magneto-optical substrate with a dichroic mirror.

In an embodiment including a dichroic mirror, the mirror may be designed to reflect in the green to blue wavelengths for example, but allow light in the red wavelengths to be transmitted through the mirror. In one embodiment, the first light source 140 is polarized by polarizer 142 and produces a green/blue (i.e., cyan) light. Light sources 1950 and 1960, which are not polarized, may be red light sources. Such a configuration provides, among other things, the ability to independently optimize the lighting conditions for the magnetic and optical readings. For example, different intensities may be selected for the blue/green and red light sources, wherein magnetic information may be represented by reflected green/blue spectrum light and optical information may be represented by reflected red spectrum light. In this embodiment the red spectrum is primarily used for obtaining optical information. Since this red spectrum is not polarized it is not affected by the orientation of the second polarizer 148 and the orientation of that polarizer may be chosen to optimize the magnetic image (which is based primarily on the polarized cyan light).

FIGS. 20A-20D is a simplified graphical representation of a reading element in accordance with an embodiment of the present invention. It is to be understood that FIGS. 20A-20D are simplified in order to facilitate a better understanding of embodiments of the invention. Thus the reading element depicted in FIGS. 20A-20D may also contain components depicted in FIG. 19C (for example lenses and other components are omitted from FIGS. 20A-20D as they are not directly relevant to the discussion related to these figures). The relative positions of the components shown in FIGS. 20A-20D are for illustrative purposes and may be different in other embodiments.

The embodiment depicted in FIGS. 20A-20D is configured to read optical and magnetic information of a tag 102 without a mirror layer on the surface of the magneto-optical substrate 138 (although the concept can also be used to enhance images with a mirror layer present). In some embodiments, most of the light passes through the magneto-optical substrate 138 and is reflected by the tag 102 under the substrate 138. In such embodiments, a highly-reflective tag surface may be desired. If the surface of the tag 102 is sufficiently reflective, light may be reflected from at least some portions of the surface of the tag 102 and pass through the polarizer 148 to be captured by the optical detector 150. In alternative embodiments, the magneto-optical substrate 138 may be configured to partially or fully mirror light from a light source.

FIGS. 20A-20D show optical detector 150, the magneto-optical substrate 138, the polarizer 148, and polarizers 2010 and 2020 respectively positioned in front of a green light source (not shown) and a red light source (not shown). In other embodiments, the light source color may be any suitable color. Polarizer 2010 is rotated counterclockwise with respect to the orientation of polarizer 148. Polarizer 2020 is rotated clockwise with respect to the orientation of polarizer 148.

In FIG. 20B, the plane of polarization of green light 2030 is rotated counterclockwise with respect to the orientation of polarizer 148 as the green light passes through polarizer 2010. Similarly, the plane of polarization of red light 2040 is rotated clockwise with respect to the orientation of polarizer 148 as the red light passes through polarizer 2020. Note that in FIGS. 20B-20D the arrows shown represent the polarization angle of the light in question and do not necessarily represent the direction that the light is travelling. Both green light and red light travel towards the magneto-optical substrate 138.

In FIG. 20C, green light and red light reflect off the tag 102 under the magneto-optical substrate 138 and travel towards polarizer 148. A magnetic field from the tag 102 causes the plane of polarization of at least some portion of green light and red light to rotate clockwise with respect to their initial planes of polarization 2030 and 2040 respectively. After the rotation the new planes of polarization are depicted by arrows 2050 (for the green light) and 2060 (for the red light). The rotations of the planes of polarization are not intended to be to scale and could be exaggerated for illustrative purposes. Optical features of the tag 102 alter at least some portion of both green light and red light (e.g. black areas would absorb light whereas shiny areas would reflect it); thus, optical information is carried by both.

FIG. 20D shows a graphical representation of the planes of polarization of the green light 2070 and red light 2080 that passed through polarizer 148. A greater proportion of the green light than the red light passes through the polarizer 148 because the green light is better oriented to pass through polarizer 148. Specifically, in this embodiment, the portion of green light better oriented to pass through polarizer 148 was oriented counterclockwise due to polarizer 2010 and underwent clockwise rotation by the presence of a magnetic field of tag 102. The bold arrows represent the proportion of each light which is able to pass through polarizer 148. Thus, assuming green light and red light entered polarizer 148 with equal brightness, green light exits polarizer 148 brighter than red light.

The differential in the green light and red light reaching the optical detector 150, is used to analyze the optical and the magnetic information of tag 102. In some embodiments, the optical detector 150 will process green light and red light to form green channel information and red channel information. Hence, the channels may be used to form images based on green channel information and red channel information. These images may be combined to enhance magnetic or optical information (herein “combined” or “combination” mean any form of mathematical operation involving both sets of information, e.g. “combined” may also mean subtracted, or used with a linear or non-linear equation to extract certain information using both sets of information together).

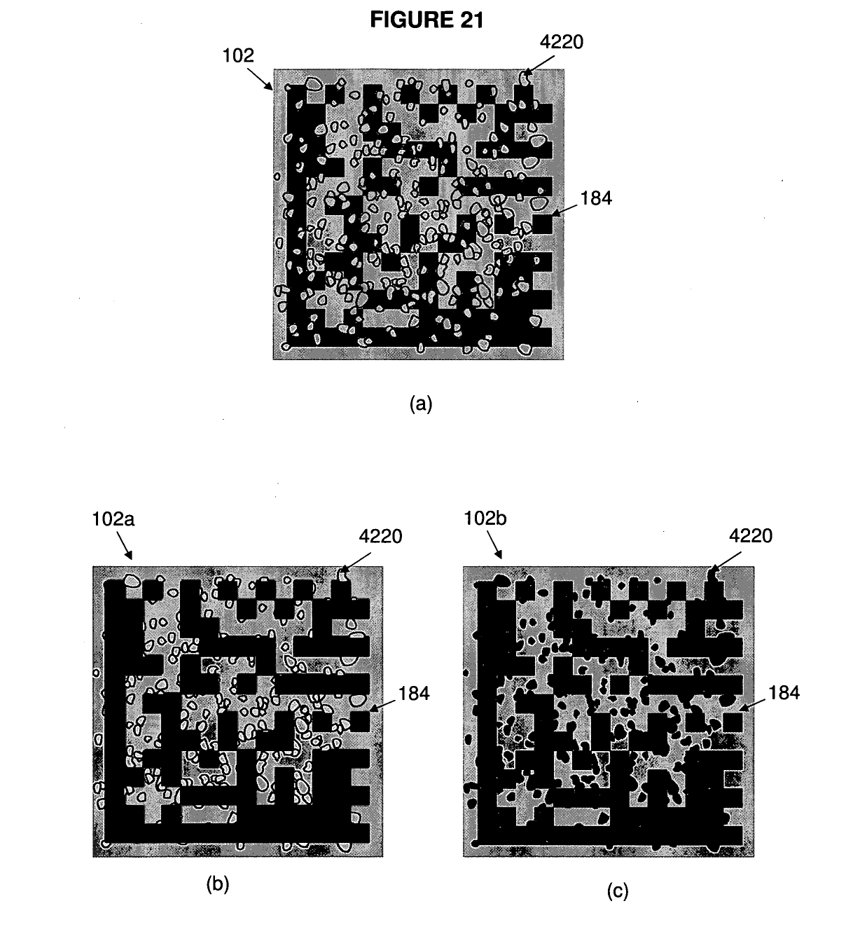

FIG. 21A shows a top view of a tag 102 with optical features 184 and magnetic features 4220 artificially superposed in accordance with an embodiment of the invention. FIG. 21B shows a green-spectrum image 102a of the tag 102 taken using a reading element as described in FIGS. 20A-20D. FIG. 21C shows a red-spectrum image 102b of the tag 102a taken using a reading element as described in FIGS. 20A-20D. Here it is assumed that the magneto-optical substrate does not have a mirror layer and that the light is being reflected off a shiny tag surface (except where the black optical markings are, where the light is assumed to be completely absorbed). It will be apparent to anyone skilled in the art that the idealized images shown in FIGS. 21B and 21C are highly dependent on the optical set up, and very different images would be obtained if the optical or tag surface conditions are changed.

In some embodiments, if the optical information affects the red and green light in a similar manner, generating a difference image of green-spectrum image 102a and red-spectrum image 102b may remove, or at least diminish, the optical features 184, but enhances the magnetic features 4220. That is, green-spectrum image 102a and red-spectrum image 102b similarly convey optical features 184, but the green-spectrum image 102a will have different values than the red-spectrum image 102b where the magnetic features 4220 are located. Generating a summation image of green-spectrum image 102a and red-spectrum image 102b may result in the optical features 184 becoming prominent; partly because the summation image may result in reduced or nullified magnetic features 4220 due to the difference in values of the magnetic features 4220 in the green-spectrum image 102a and red-spectrum image 102b.

One of ordinary skill in the art will understand that more complex analysis may be necessary to adequately resolve the optical features 184 and the magnetic features 4220. For example, green-spectrum image 102a and red-spectrum image 102b may contain information that is a combination of the magnetic 4220 and optical 184 features where the magnetic 4220 and optical 184 features overlap. Further, although all the magnetic features 4220 are shown with uniform light color or intensity, variation in light intensity or color across each magnetic feature 4220 may occur. As with elsewhere in this disclosure, the terms “difference” or “summation” are understood to include complex non-linear equations to “subtract” or “add” images to enhance the features being investigated. For example, it is usually not practically possible to get images with completely uniform lighting conditions such as the images shown throughout this disclosure. In most cases the lighting will be brighter in some areas than in others (for example brighter in the centre of the image than at the edges). Such non-uniform lighting effects both the optical and magnetic information being interrogated. For example assume that there are two magnetic features of equal magnetic field strength, one in the centre of the image (where the light has a brightness of 100 units) and one at the edge of the image where the light is less bright (assume a brightness of 10 units). Assume that the background is subtracted from the image. For simplicity assume that due to the magnetic features the magneto-optical substrate rotated the polarization of the light such that an additional 10% of the light present passes through the second polarizer. 10% at the bright area is 10 units of light, whereas 10% at the dimmer edge is only 1 unit of light. Therefore the magnetic feature in the centre of the image will appear brighter than the one at the edge of the image after the background has been subtracted. Consequently, throughout this invention the terms “summation”, “combination”, “addition” and other mathematical terms are understood to include more complex operations than just simple linear addition or subtraction.

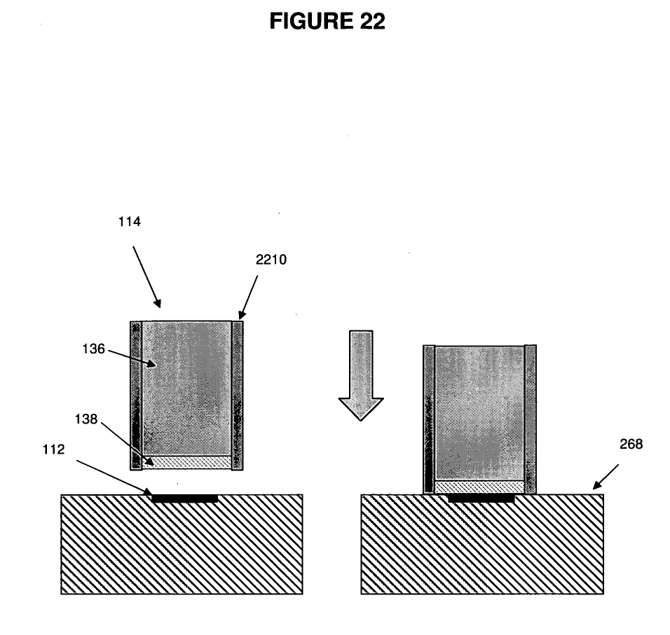

FIG. 22 shows a method of reading a fingerprint region 112 on a tag 102 embedded on the level surface 268 of an item of value using a magneto-optical reading element 114 in accordance with an embodiment of the invention. The reading element 114 is a magneto-optic reading element and consists of a magneto-optical substrate 138 and an optical processing unit 136 combined to form the reading element 114. The reading element 114 is surrounded by a sheath 2210 which protects the reading element 114 from damage. The sheath 2210 can be made from non-magnetic material such as non-magnetic metals (such as aluminum), non-magnetic ceramics or plastics. In certain circumstances it is desirable to make the sheath 2210 (or other component around, or of, the reading element) weakly magnetic as this can enhance the magnetic field being detected by the reading element 114. For example if the tag 102 is magnetized such that the magnetic features of the fingerprint region 112 have their north pole facing the reading element 114 during reading it can be advantageous to have weakly magnetized the reading element 114 or some component near the reading element 114 such that the reading element 114 appears to be a south pole of a magnet. This can enhance the field being detected since the south pole of the reading element 114 will attract the north poles of the features thereby warping the magnetic flux lines such that they extend further out of the plane of the tag 102. Alternatively it can be advantageous to make, for example the left side of the reading element 114 a weak north pole and the right hand side a weak south pole. This may warp the magnetic flux lines in the plane of the magnet (predominantly) and may mean that the readings may be reader dependent (i.e. dependent on the specific magnetization of the reading element used). This may be used to ensure that different scanners may not be able to read certain tags (since the fingerprints may not match). The left side of FIG. 22 shows the reading element 114 before it is contacted with the magnetic fingerprint 112 and the right side of FIG. 22 shows the reading element 114 in contact with the magnetic fingerprint 112. The method of reading the fingerprint region 112 on the level surface 268 is achieved by first bringing the magneto-optical reading element 114 into contact with the magnetic fingerprint region 112 and then activating a button on the reading device 104. Once the button is activated, an image signal can be obtained and the reading procedure is completed.

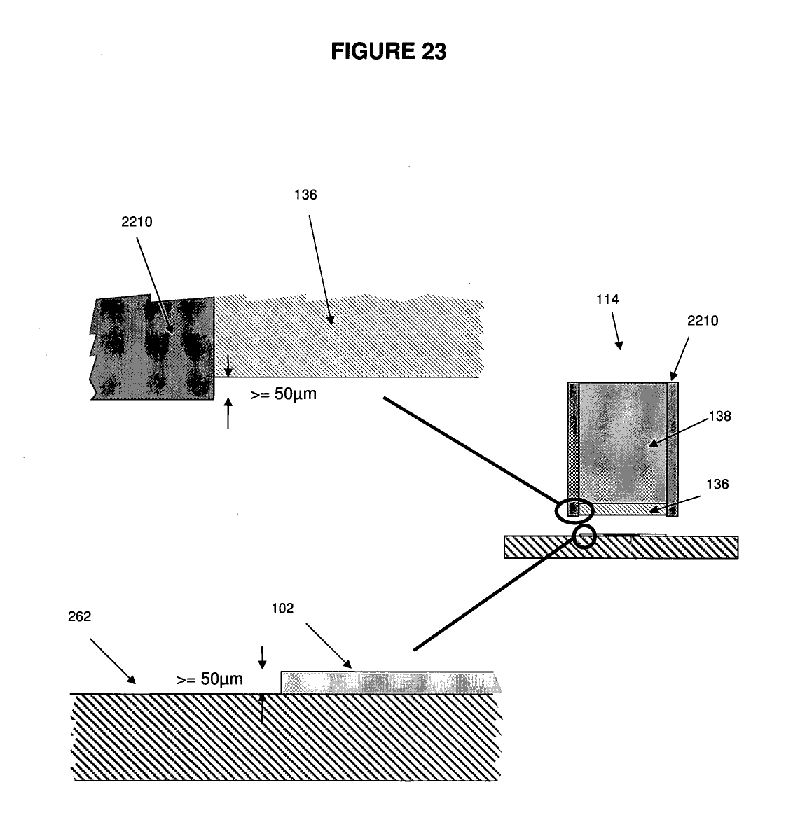

FIG. 23 shows a magneto-optical reading element 114 and a tag 102 in accordance with an embodiment of the invention. On the left side of FIG. 23, the components have been magnified so that it is easy to see how they can fit together. In one embodiment, the sheath 2210 may act like an engagement element for positioning the magneto-optical substrate 138 over an area of the magnetic fingerprint on the tag 102. Also in order to minimize potential damage on the magneto-optical reading element 114, the magneto-optical reading element 114 can be designed to lie below the surface of the sheath 2210. If a tag 102 or portion of a tag 102 is at least 50 micrometers thick the recess formed by the sheath 2210 and reading element 114 can be used as a physical alignment method to allow the user to align the reading element 114 to the tag 102. The reading element 114 lies at least about 50 micrometers, at least about 150 micrometers, of at least about 200 micrometers or at least 250 micrometers, for example, below the surface of the sheath 2210. Usually the tag 102 used for this may be designed to have a thickness of at least 50 micrometers, and may be at least as thick if not thicker than the distance that the reading element 114 lies below the surface of the sheath 2210. Note that in certain circumstances effective physical alignment may be achieved by having only one side of the sheath 2210 lying above the level of the reading element 114, in this case the lip formed by the sheath 2210 sticking above the level of the reading element 114 may be used to guide the edge of the reading element 114 to the edge of the tag 102 or other physical step formed in the surface of the tag 102, or label, or item of value.

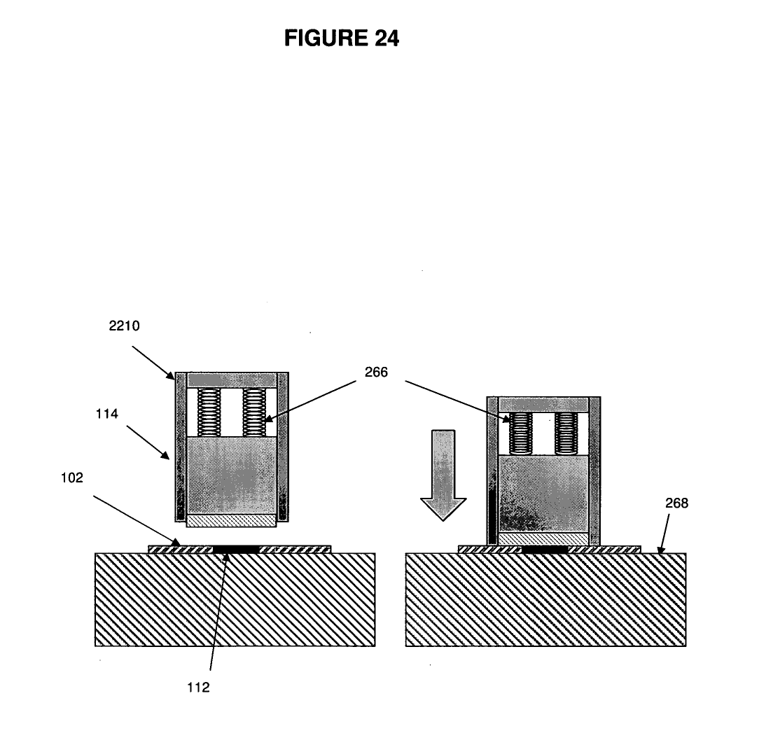

FIG. 24 shows a method of reading a tag 102 on a level surface 268 using a magneto-optical reading element 114 in accordance with another embodiment of the invention. The magneto-optical reading element 114 is able to slide within a protective sheath 2210 via a conformation element 266 (shown as a simple set of springs). The left side of FIG. 24 shows the reading element 114 before it is contacted with the tag 102 and the right side of FIG. 24 shows the reading element 114 in contact with the tag 102. When the reading device 104 is brought in contact with the tag 102, the reading element 114 is pushed against the surface of the tag 102. The conformation element 266 ensures that the reading element 114 exerts some pressure on the tag 102, but not so much pressure as to damage the reading element 114 or the critical, fingerprint region 112 of the tag 102. This is because the design of the conformation element 266 defines the maximum pressure that the reading element 114 will exert on the tag 102, even if the reading device 104 is pushed very hard, the reading element 114 will retreat into the sheath 2210 and eventually the walls of the sheath 2210 will take the excess pressure. The conformation element 266 may include a spring system, a sponge system, a suction system, a hydraulic system and/or a pneumatic system. The conformation element 266 allows the magneto-optical read head 114 and the tag 102 to be in constant contact during the reading process even if the user applies uneven force during reading.

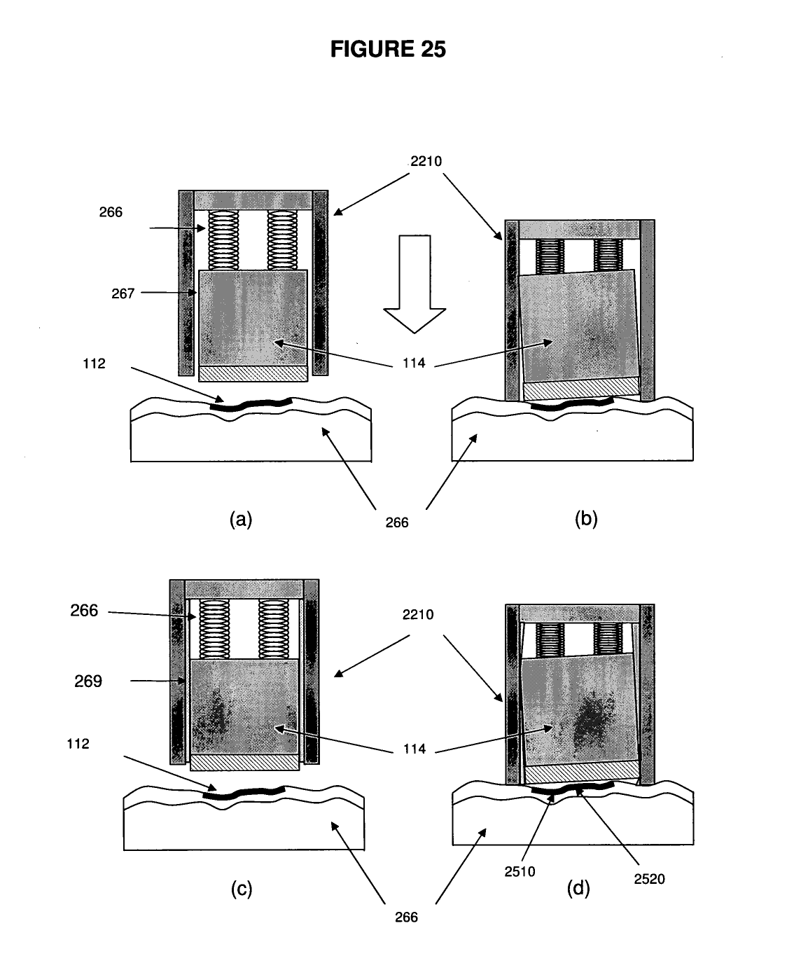

FIGS. 25A to 25D shows a method of reading a tag 102 on an uneven surface 268 using a magneto-optical reading element 114 in accordance with another embodiment of the invention. FIG. 25A shows a magneto-optical reading element 114 having a small gap 267 to the surrounding protective sheath 2210. In addition, the magneto-optical reading element head 114 is connected to the sheath 2210 via a conformation element 266, for example a spring mechanism. Both the gap 267 and the spring mechanism 266 provide a certain degree of compensation when reading the magnetic fingerprint region 112 or the tag 102 on an uneven surface 268. FIG. 25A shows the reading element 114 prior to engaging it with the tag 102. In FIG. 25B, the magneto-optical reading element 114, as shown in FIG. 25A, is brought to be in contact with the tag 102 on an uneven surface 268, the magneto-optical reading element 114 is able to move within the sheath 2210 so as to conform to the tag 102 on the uneven surface 268. In FIG. 25C and FIG. 25D, the gap 267 may be replaced with a compliant layer 269 to compensate for the movement of the magneto-optical read head 114 (FIG. 25C shows the situation prior to contact and FIG. 25D shows the situation during contact with the tag 102). Note that the strength of the magnetic fields of the magnetic features within the fingerprint region 112 decay rapidly with distance. Assume that two magnetic features are situated at the same depth into the tag (that is measured from the tag surface) and that these two features have the exact same magnetic strength and orientation of their magnetic fields. If one such feature is situated at location 2510 on the tag 102 and the other at 2520, a reading of the tag as shown in FIG. 25D will result in the reading element 114 measuring a stronger contribution from the magnetic feature at a location 2520 than from the magnetic feature at a location 2510 since, because of the topography of the surface 268, the magnetic feature at the location 2520 is physically closer to the reading element 114 than the magnetic feature at the location 2510. Consequently the reading will actually be a measurement of the magnetic features of the tag 102 convoluted with the topography of the tag 102 or surface 268. In some cases this may be used as a powerful tamper-proofing or tamper-resisting mechanism since if the tag 102 is removed from one surface and placed on another the fingerprint reading will change with the change of topography that it is placed on. In other circumstances, particularly in the case where tags are initially read on a production line prior to being applied to the surface of an item of value, this may cause problems since the initial reading of the tag 102 may not match well with the subsequent readings of the tag 102 due to the topography. In such circumstances it can be advantageous to use a compliant tag. Another method may be to use tags 102 which can be molded to have their reverse sides fit with the contours of the surface they are applied to, however the front surface of the tag should remain planar. An example of such a tag 102 may be a multilayer tag with a hard planar front layer and an underlying layer (below the fingerprint region) made from a thermoplastic material. When the tag 102 is applied to the item of value, it is heated such that the thermoplastic layer melts or at least softens such that it may conform to the surface of the item of value.

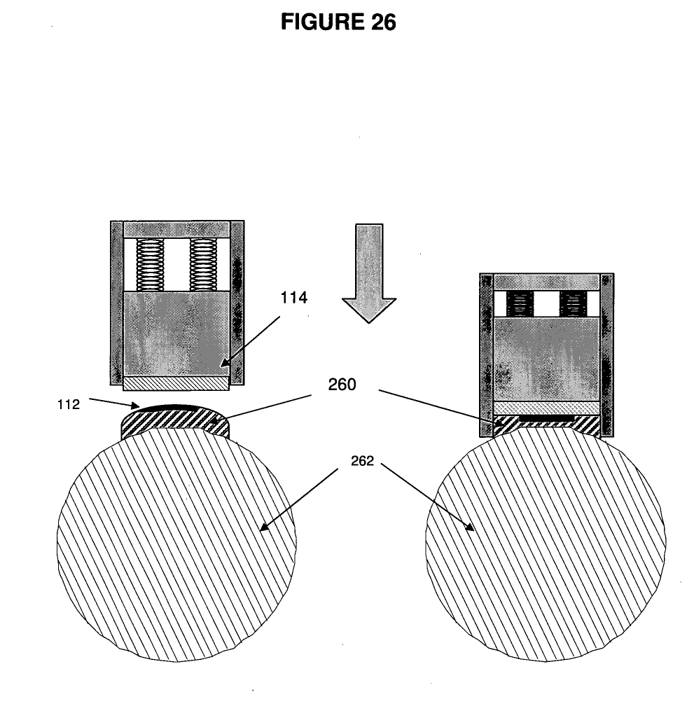

FIG. 26 shows a method of reading a fingerprint 112 contained in a compliant label 260 using a magneto-optical reading element 114 in accordance with an embodiment of the invention. Here the compliant label 260 is shown attached to an item of value 262 having a circular cross section. Due to the shape of the item of value 262, the surface of the compliant label 260 is also curved prior to engagement with the reading element 114 (as shown on the left side of the figure). Due to its compliance, the surface of the label 260 is able to deform to a flat surface when engaged by the reading element 114 (as shown on the right side of the figure). This allows good contact between the fingerprint region 112 of the label and the reading element 114. It is important however that the label 260 is not so thick or so compliant that the fingerprint region 112 is significantly distorted in the plane of the label 260 during reading—significant distortion may allow the magnetic features within the fingerprint region 112 to be displaced relative to each other and this may reduce the matching between the stored fingerprint signal and the read fingerprint signal.

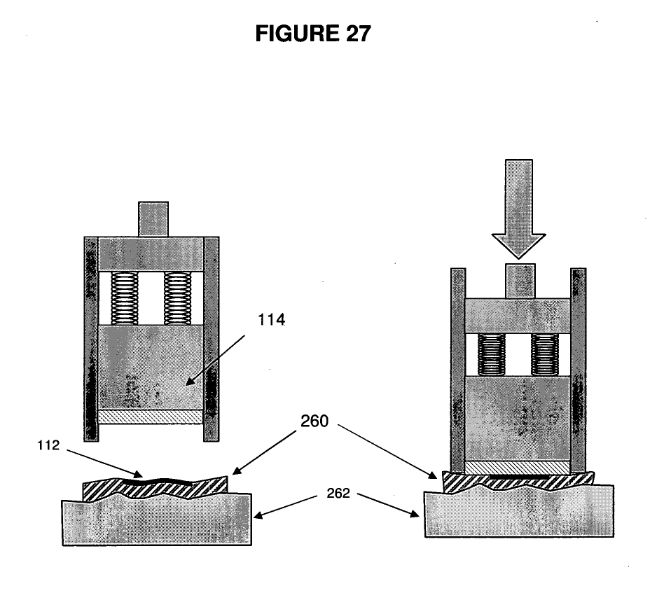

FIG. 27 shows how a compliant label 260 can assist when the item of value 262, to which the label 260 is affixed, has a rough surface. The left side of FIG. 27 shows the situation prior to engagement with the reading element 114. The label 260 conforms to the surface of the item of value 262 causing the label's surface to be undulating. In general, the fingerprint 112 is first read on a production line where the label 260 is kept flat. If the subsequent reading is made when the label 260 has an undulating surface, certain magnetic features of the fingerprint region 112 may be further away from the surface of the reading element 114 if the label 260 is not compliant. However during reading (engagement with the reading element 114 with some pressure applied to the reading element 114) with a compliant label 260, as shown on the right side, the surface of the fingerprint region 112 is able to conform to the reading element 114, thereby facilitating an accurate reading of the fingerprint region 112.

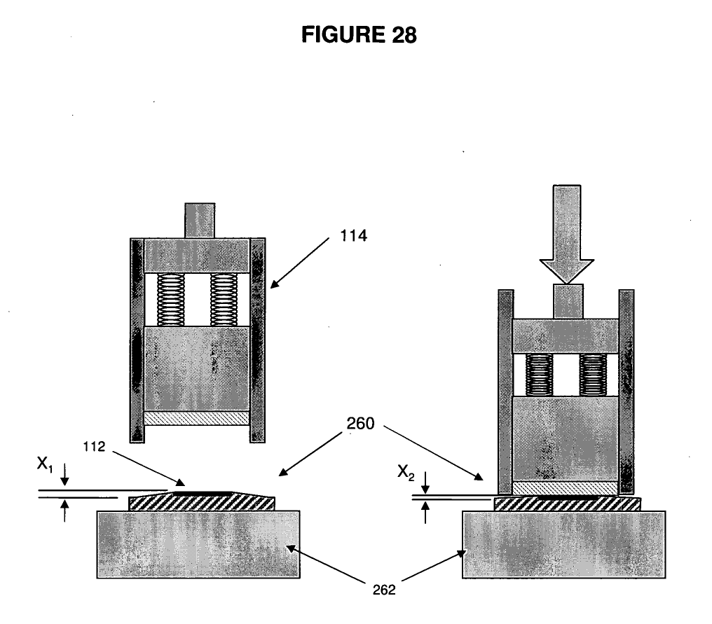

FIG. 28 shows another compliant label formation in accordance with an embodiment of the invention. Here the label 260 is constructed such that the surface of the fingerprint region 112 is slightly raised with respect to the remaining surface of the label 260 surrounding the fingerprint region 112. As shown on the right side of the figure, when attached to a flat item of value 262 prior to engagement with the reading element 114, the surface of the fingerprint region 112 is raised by a distance of X₁ above the surface at the edge of the label 260. As shown on the left side of FIG. 28, during engagement this distance is compressed to X₂, that is, the surface of the fingerprint region 112 is compressed to lie closer to the plane of the surrounding surface. Depending on the shape or size of the reading element 114 and the pressure exerted on the reading element 114 during reading, X₂ may be zero (i.e. lying in plane with the surrounding surface) or even negative (i.e. the fingerprint region's surface is pushed below the surrounding surface). This label 260 design facilitates good contact between the fingerprint region 112 and the reading element 114 since all the pressure exerted on the reading element 114 is concentrated towards flattening the surface of the fingerprint region 112, and if the other portions of the label 260 are slightly raised (for example due to a burr or lip formed during die cutting, or due to damage), or if the other portions have dirt on them, they will not have a marked effect on the reading of the fingerprint region 112.

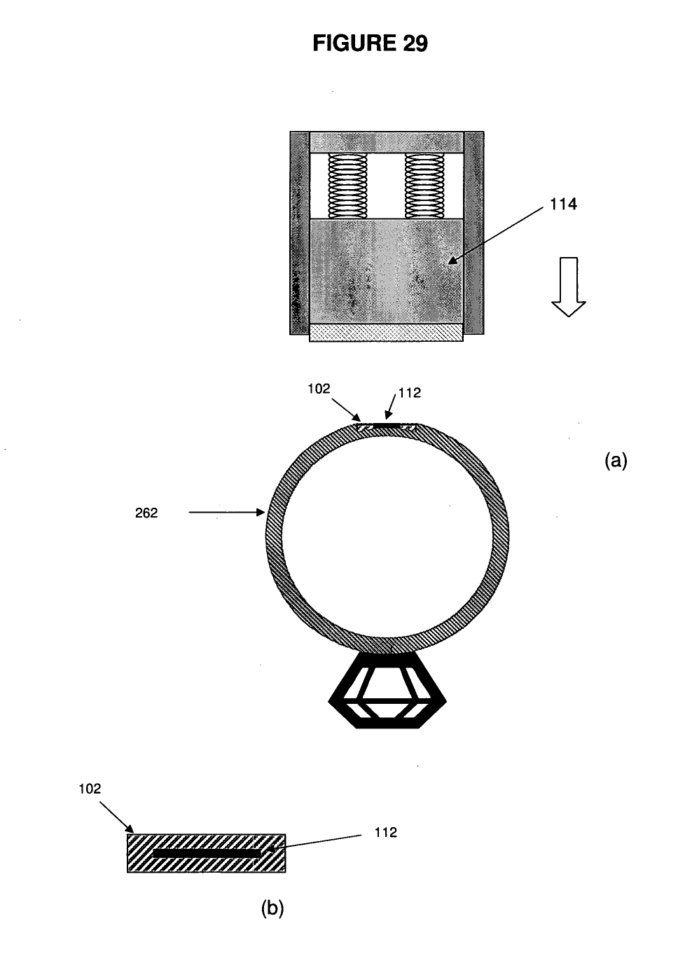

FIG. 29A shows a cross-sectional view of a tag 102 containing a fingerprint region 112 in accordance with an embodiment of the invention. The tag 102 is embedded in an object of value 262 (for example a ring) to be identified and a magneto-optical reading element 114 in accordance with an embodiment of the invention. The surface of the ring 262 which contains the tag 102 has been flattened to ensure good contact between the surface of the tag 102 and the reading element 114. The magneto-optical reading element 114 is brought into contact with the tag 102 for reading the magnetic fingerprint 112. FIG. 29B shows a plan view of the tag 102 and a fingerprint region 112 in accordance with an embodiment of the invention. Here the tag 102 is rectangular to fit with the space available on the ring surface. The fingerprint region 112 is an elongated groove containing fingerprint material. It may also be feasible and may be desirable to plate a thin metal layer over the tag 102 for aesthetic purposes (for example to look the same as the surrounding ring)—for example if the ring is gold then the plating of the ring 262 can be gold. This plating (or other coating) can also serve to protect the tag 102 and fingerprint region 112 from the environment (for example scratching and corrosion). An important feature of the invention is highlighted in this embodiment: that a single scanner with one standard reading element can read fingerprint regions of various shapes and sizes and contained in or attached to the surface of a variety of items of value. Provided that the standard reading device 104 (and associated magneto-optical reading element) is able to read a sufficiently large proportion of the fingerprint region 112 in order to ensure fingerprint matching above an acceptable threshold value it is not necessary that all the fingerprint regions 112 are the same shape and size. This is very important commercially because it allows the use of a standard reading device 104 or scanner for use with a wide variety of products.

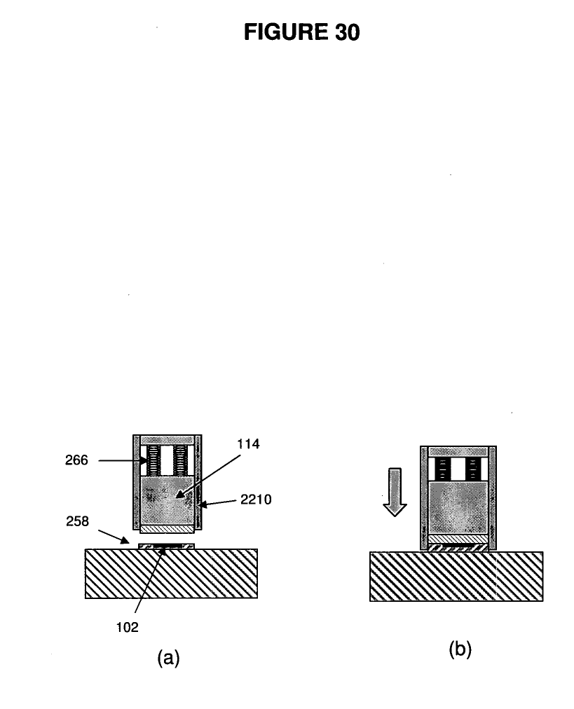

FIG. 30A and FIG. 30B show cross-sectional views of a magneto-optical reading element 114 when reading a tag 102 in accordance with an embodiment of the invention. The magneto-optical reading element 114 is surrounded by a protective sheath 2210. The magneto-optical read head 114 is connected by means of a spring mechanism 266, to the sheath 2210. The internal walls of the sheath 2210 are essentially complementary in shape to a perimeter of a thick label 258 in which the tag 102 with a set of identification features is positioned.

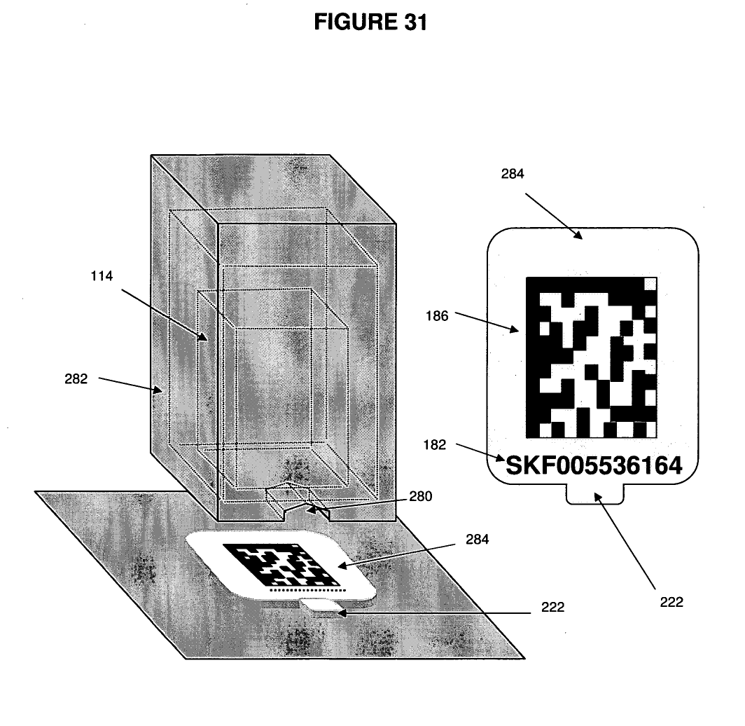

FIG. 30A shows the situation prior to engaging the magneto-optical reading element 114 with the thick label 258. The springs 266 are in an uncompressed state. FIG. 30B shows the magneto-optical reading element 114 being compressed against the thick label 258 when reading the tag 102. The protective sheath 2210 substantially surrounds the thick label 258. When the magneto-optical read head 114 is compressed against the thick label 258, the springs 266 are compressed and the magneto-optical reading element 114 is pushed inside the sheath 2210. The internal walls of the sheath 2210 surround the label 258 and provide the user with a physical engagement mechanism to ensure that the reading device 104 is correctly aligned to the label 258 (and therefore to the tag 102 and its fingerprint region 112). The label 258 and sheath 2210 can be of any suitable shape, for example a square, rectangle, triangle or polygon, however it is preferable that the shape is not completely symmetrical, i.e. that the shape uniquely defines the orientation of the reading device 104 or scanner with respect to the label 258. Such a label 258 and sheath 2210 configuration is shown in FIG. 31, described below.

FIG. 31 shows a method of reading a label 284 with an alignment feature 222 using a magneto-optical reading element 114 in accordance with an embodiment of the invention. The label 284 contains an embedded fingerprint region 112 covered by a thin cover layer 160 (the fingerprint region 112 is not shown since it is hidden by the cover layer 160). A Data Matrix barcode 186 and human-readable serial number 182 are printed on the surface of the cover layer 160. To achieve a desired alignment for reading the fingerprint on the label 284, a combination of a notch 280 on a housing 282 surrounding or adjacent to the magneto-optical reading element 114 and a stub 222 on a label 284 can be used to provide an interlocking means. As the magneto-optical reading element 114 is brought upon the label 284, the notch 280 on the housing 282 of the magneto-optical reading element 114 provide a mechanical guide to ensure accurate alignment and orientation of the scanner with respect to the label. The interlocking prompts the user to adjust the magneto-optical reading element 114 to the label 284 in a preferred alignment. Note that the housing 282 may be a protective sheath as described with reference to previous figures.

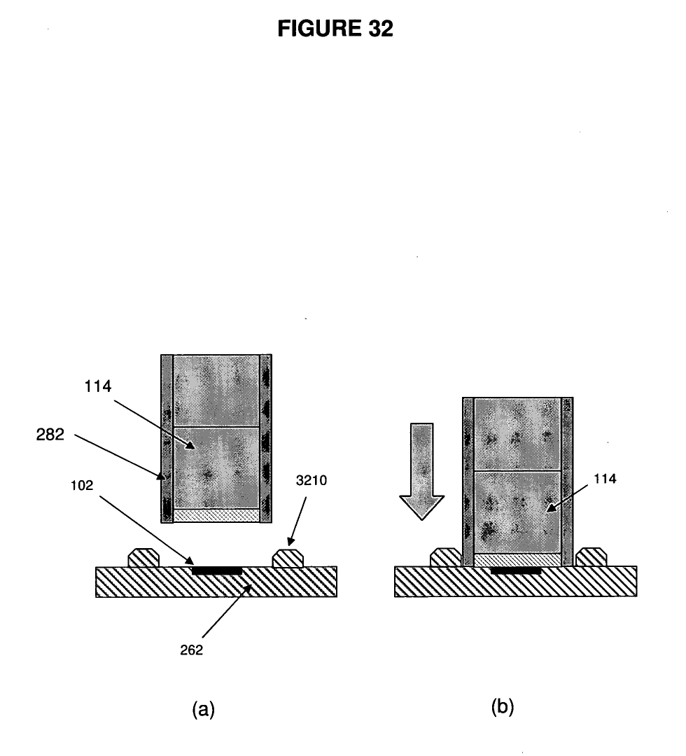

FIG. 32 shows a method of reading a tag 102 containing a fingerprint 112 in accordance with an embodiment of the invention. The tag 102 is embedded in the surface of an item of value 262. The item of value 262 has a protrusion or protrusions 3210 adjacent to the tag 102. These protrusions 3210 are designed to guide or interlock with the housing 282 of the magneto-optical reading element 114. FIG. 32A shows the situation prior to engagement between the reading element 114 and tag 102. FIG. 32B shows the situation during engagement. Here the magneto-optical reading element 114 is moved down such that the magnetic reading element 114 contacts (or at least is in close proximity to) the surface of the tag 102. The protrusions 3210 act to guide the position of the reading element 114 with respect to the tag 102. Note that protrusions 3210 may completely surround the tag 102 or the housing 282 and protrusions 3210 may also be formed on the tag 102 itself or on a label to help guide the alignment.

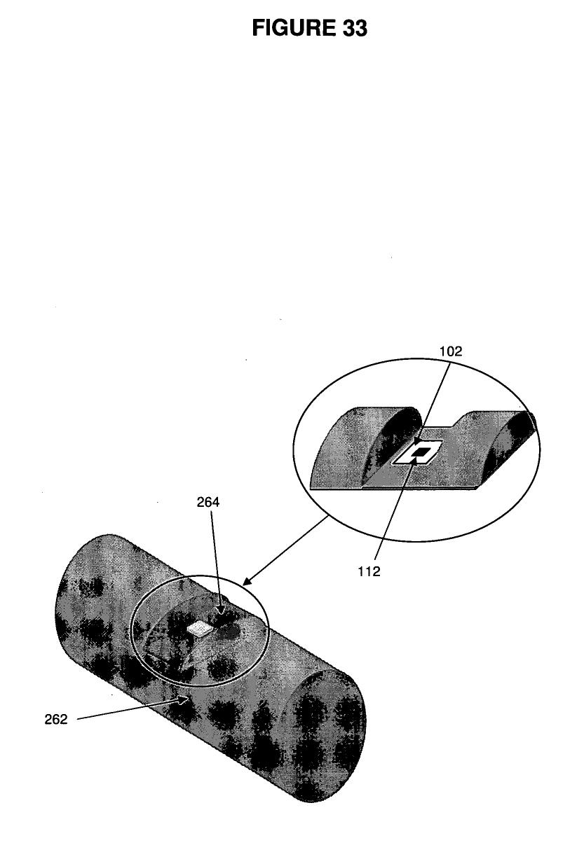

FIG. 33 shows a tag 102 containing a magnetic fingerprint 112 in a groove 264 of an object 262 to be identified in accordance with an embodiment of the invention. The walls of a groove 264 for the tag 102 can be used to help align the reading device 104 or scanner and tag 102 as is described in relation to FIG. 18. Such a groove 264 is also advantageous if the object 262 to be identified has no suitable flat surfaces on which to attach the tag 102. Such objects include cylindrical objects but not so limited. Such a groove 264 also has the advantage that it helps to protect the tag 102 from mechanical abrasion and inadvertent contact with objects. Note that the groove 264 need not be an open-ended trough as shown in FIG. 33, any depression, e.g. a four-walled square section depression may be suitable.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A reading device for reading magnetic and optical information, the reading device comprising a reading element, the reading element comprising a magneto-optical substrate adapted to read overlapping magnetic identification features and optical identification features, wherein the magneto-optical substrate is at least partially optically transparent.

2. The reading device of claim 1, wherein the magneto-optical substrate comprises a layer arrangement, the layer arrangement comprising:
an optically transparent substrate;
a first coating layer; and
a second coating layer.

3. The reading device of claim 2, wherein the second coating layer is partially optically transparent and partially reflective.

4. The reading device of claim 3, wherein the second coating layer reflects at least a portion of light, wherein the light is monochromatic.

5. The reading device of claim 3, wherein the second coating layer comprises a dichroic mirror.

6. The reading device of claim 3, wherein the second coating layer comprises a dielectric mirror.

7. The reading device of claim 2, wherein the second coating layer is configured to change a reflective property.

8. The reading device of claim 7, wherein the second coating layer is a switchable mirror.

9. The reading device of claim 7, wherein the reflective property is selected from a group consisting of a polarization property and a wavelength property.

10. The reading device of claim 1, wherein the reading device is configured to generate an alternating current to induce a magnetic field with the magnetic identification features.

11.-12. (canceled)

13. The reading device of claim 1, wherein the reading device comprises a light source configured to generate at least two monochromatic light signals, the at least two monochromatic light signals being of a wavelength capable of producing an image of the optical identification features or an image of the magnetic identification features.

14. The reading device of claim 13, wherein one of the at least two monochromatic signals passes through a polarized lens.

15. (canceled)

16. The reading device of claim 1, wherein the reading device comprises two or more light sources, wherein a first light source is configured to generate a monochromatic light signal capable of producing an image of the optical identification features and a second light source is configured to a monochromatic light signal capable of producing an image of the magnetic identification features.

17.-18. (canceled)

19. A reading device for reading magnetic and optical information, the reading device comprising:
a reading element comprising a magneto-optical substrate, the magneto-optical substrate comprising:
a reflective layer configured to reflect a first portion of light; and
a transparent layer configured to pass through a second portion of light;
wherein the reflective layer and the transparent layer overlap to form an overlap region, the overlap region being capable of reading both magnetic and optical information of an object.

20. The reading device of claim 19, wherein the magneto-optical substrate comprises a layer arrangement, the layer arrangement comprising:
an optically transparent substrate;
a first coating layer; and
a second coating layer, wherein the second coating layer is partially optically transparent and partially reflective.

21.-32. (canceled)

33. The reading device of claim 19, wherein the reading device comprises two or more light sources, wherein a first light source is configured to generate a monochromatic light signal capable of producing an image of the optical identification features and a second light source is configured to a monochromatic light signal capable of producing an image of the magnetic identification features.

34. The reading device of claim 33, wherein at least one of the monochromatic light signals passes through a polarized lens.

35. (canceled)

36. The reading device of claim 2, wherein the first coating layer is a magneto-optic film.

37.-45. (canceled)

46. The reading device of claim 1, wherein the reading element is adapted to conform to the tag or object to be identified when brought into contact with the tag or object to be identified.

47.-53. (canceled)

54. A method of identifying a tag or an object adapted to be identified, the method comprising:
generating a first signal from a magneto-optical reading of a first set of identification features located in the tag or object adapted to be identified only, wherein a first set of identification features comprises a disordered arrangement of magnetic or magnetisable particles included in an identification layer of the tag or object, wherein the first signal generated from reading the first set of identification features as such is used to derive a first signature for identifying the tag or object; and
generating a second signal from reading a second set of identification features, wherein the second set of identification feature comprises optical identification features, wherein the first set of identification features and the second set of identification features at least partially overlap.

55.-91. (canceled)
